(19) United States
(12) Patent Application Publication
(10) Pub. No.: US 2014/0092147 A1
(43) Pub. Date: Apr. 3, 2014

(54) DISPLAY APPARATUS AND CONTROL METHOD THEREFOR

(71) Applicant: CANON KABUSHIKI KAISHA, Tokyo (JP)

(72) Inventors: Takushi Kimura, Kawasaki-shi (JP); Takeshi Ikeda, Ebina-shi (JP)

(21) Appl. No.: 14/040,903

(22) Filed: Sep. 30, 2013

(30) Foreign Application Priority Data
Oct. 1, 2012 (JP) 2012-219476
May 29, 2013 (JP) 2013-112644
Sep. 4, 2013 (JP) 2013-182851

(51) Int. Cl. G09G 3/36

(52) U.S. Cl. CPC G09G 3/3607
USPC 345/690; 345/87

(57) ABSTRACT

A display apparatus according to the present invention comprises: a display unit configured to display an image based on image data; and an output unit configured to generate image data in which, among pixel values of image data generated by applying predetermined image processing to input image data, a pixel value outside a predetermined range is limited to a value within the predetermined range and a pixel value of a pixel around the pixel, the pixel value of which is limited, is adjusted such that a change in brightness due to the limitation of the pixel value outside the predetermined range is suppressed, and configured to output the image data to the display unit.

### BACKGROUND OF THE INVENTION

1. Field of the Invention

The present invention relates to a display apparatus and a control method therefor.

2. Description of the Related Art

There is a technique for controlling, in a liquid crystal display apparatus, the light emission brightness of a backlight and the transmittance of a liquid crystal panel concerning each of a plurality of divided regions (backlight regions) that form a region of a screen (e.g., Japanese Patent Application Laid-Open No. 2002-99250). In the technique, for example, a low value is set as the light emission brightness of the backlight in the divided region where a dark image is displayed and a high value is set as the light emission brightness of the backlight in the divided region where a bright image is displayed. Image data (the transmittance of the liquid crystal panel) is corrected according to the light emission brightness of the backlight such that the brightness of an image displayed on the screen is equal when the backlight is caused to emit light at predetermined light emission brightness and when the backlight is caused to emit light at light emission brightness based on the lightness of the image. By performing such control, it is possible to suppress floating black and improve contrast.

However, an image displayed in the divided region sometimes includes both a light region and a dark region. In such case, if the light emission brightness of the backlight is increased in order to secure the brightness of the light region, a pixel value (the transmittance of the liquid crystal panel) of the dark region is sometimes limited to a value equal to or larger than a lower limit value. As a result, a color of the dark region is different from a desired color, the brightness of the dark region is a value higher than desired brightness, and image quality is deteriorated. On the other hand, if the light emission brightness of the backlight is reduced in order to suppress floating black, the pixel value (the transmittance of the liquid crystal panel) is sometimes limited to a value equal to or smaller than an upper limit value. As a result, a color of the light region is different from a desired color, the brightness is a value lower than the desired brightness, and image quality is deteriorated.

As explained above, in the related art, when the pixel value is set to a value outside a predetermined range (a range between the lower limit value and the upper limit value) by image processing, image quality is deteriorated.

The deterioration in the image quality also occurs when the pixel value is set to a value outside the desired range by image processing other than the image processing for correcting the image data according to the light emission brightness of the backlight.

### SUMMARY OF THE INVENTION

The present invention provides a technique that can suppress deterioration in image quality caused by limiting a pixel value outside a predetermined range to a value within the predetermined range.

The present invention in its first aspect provides a display apparatus comprising:

a display unit configured to display an image based on image data; and

an output unit configured to generate image data in which, among pixel values of image data generated by applying predetermined image processing to input image data, a pixel value outside a predetermined range is limited to a value within the predetermined range and a pixel value of a pixel around the pixel, the pixel value of which is limited, is adjusted such that a change in brightness due to the limitation of the pixel value outside the predetermined range is suppressed, and configured to output the image data to the display unit.

The present invention in its second aspect provides a control method for a display apparatus including a display unit configured to display an image based on image data, the control method comprising:

generating image data in which, among pixel values of image data generated by applying predetermined image processing to input image data, a pixel value outside a predetermined range is limited to a value within the predetermined range and in which a pixel value of a pixel around a pixel, the pixel value of which is limited, is adjusted such that a change in brightness due to the limitation of the pixel value outside the predetermined range is suppressed; and

outputting the image data thus generated to the display unit.

According to the present invention, it is possible to suppress deterioration in image quality caused by limiting a pixel value outside a predetermined range to a value within the predetermined range.

Further features of the present invention will become apparent from the following description of exemplary embodiments with reference to the attached drawings.

### BRIEF DESCRIPTION OF THE DRAWINGS

FIG. 1 is a diagram showing an example of a functional configuration of a display apparatus according to a first embodiment;

FIGS. 2A and 2B are diagrams showing examples of a histogram and a cumulative histogram according to the first embodiment;

FIG. 3 is a diagram showing an example of a functional configuration of a correcting unit according to the first embodiment;

FIG. 4 is a diagram showing an example of a functional configuration of a limiting unit according to the first embodiment;

FIG. 5 is a diagram showing an example of processing of the limiting unit according to the first embodiment;

FIG. 6 is a diagram showing an example of a functional configuration of a compensating unit according to the first embodiment;

FIG. 7 is a diagram showing an example of processing of the compensating unit according to the first embodiment;

FIG. 8 is a diagram showing an example of a functional configuration of a compensating unit according to a second embodiment;

FIG. 9 is a diagram showing an example of a functional configuration of a display apparatus according to a third embodiment;

FIG. 10 is a diagram showing an example of a functional configuration of a correcting unit according to the third embodiment;

FIG. 11 is a diagram showing an example of a functional configuration of a compensating unit according to the third embodiment;

FIG. 12 is a diagram showing an example of a functional configuration of a compensating unit according to a fourth embodiment;

FIGS. 13A and 13B are diagrams showing an example of processing of the compensating unit according to the fourth embodiment;

FIG. 14 is a diagram showing an example of a functional configuration of a display apparatus according to a fifth embodiment;

FIG. 15 is a diagram showing an example of processing of the display apparatus according to the fifth embodiment;

FIG. 16 is a diagram showing an example of a functional configuration of a display apparatus according to a sixth embodiment;

FIG. 17 is a diagram showing an example of a histogram according to the sixth embodiment;

FIG. 18 is a diagram showing an example of a functional configuration of a correction data generating unit according to the sixth embodiment;

FIG. 19 is a diagram showing an example of a functional configuration of a limited pixel detecting unit according to the sixth embodiment;

FIG. 20 is a diagram showing an example of a functional configuration of a correction data adjusting unit according to the sixth embodiment;

FIGS. 21A to 21C are diagrams showing examples of pixel values of a limited pixel and pixels around the limited pixel according to the sixth embodiment;

FIGS. 22A to 22C are diagrams showing examples of display brightnesses of the limited pixel and the pixels around the limited pixel according to the sixth embodiment;

FIGS. 23A to 23D are diagrams showing examples of display images according to the sixth embodiment;

FIG. 24 is a diagram showing an example of a functional configuration of a display apparatus according to a seventh embodiment;

FIG. 25 is a diagram showing an example of processing of the display apparatus according to the seventh embodiment;

FIG. 26 is a diagram showing an example of a functional configuration of a display apparatus according to an eighth embodiment;

FIG. 27 is a diagram showing an example of a functional configuration of an image data correcting unit according to the eighth embodiment; and

FIG. 28 is a diagram showing an example of input image data according to the sixth embodiment.

### DESCRIPTION OF THE EMBODIMENTS

### First Embodiment

A display apparatus and a control method for the display apparatus according to a first embodiment of the present invention are explained below with reference to the drawing.

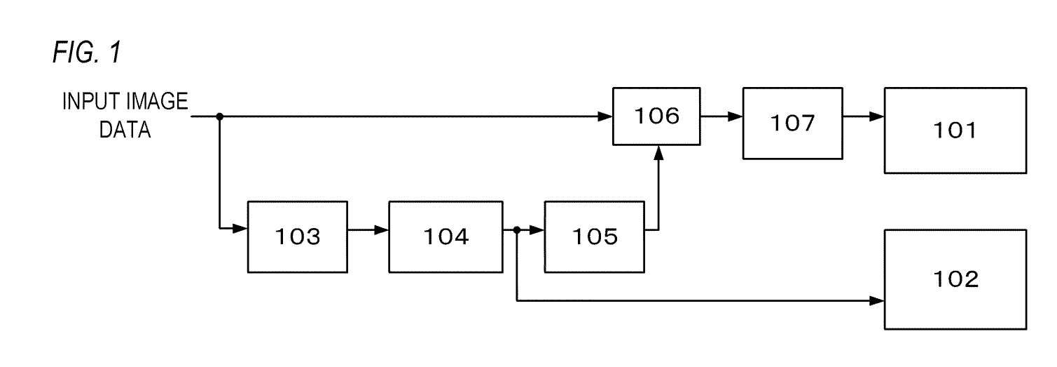

FIG. 1 is a diagram showing an example of a functional configuration of the display apparatus according to this embodiment.

The display apparatus according to this embodiment includes a liquid crystal panel unit 101, a backlight unit 102, a characteristic value detecting unit 103, a light emission brightness determining unit 104, an increase ratio determining unit 105, an increasing unit 106, and a correcting unit 107.

The liquid crystal panel unit 101 is a display unit configured to display an image based on image data input to the liquid crystal panel unit 101. In this embodiment, the liquid crystal panel unit 101 is a display unit of a transmission type including a plurality of liquid crystal elements. The liquid crystal panel unit 101 controls the transmittance of the liquid crystal display elements on the basis of the image data input to the liquid crystal panel unit 101. The liquid crystal panel unit 101 transmits light from the backlight unit 102 at the transmittance based on the image data input to the liquid crystal panel unit 101 to thereby display an image. Specifically, the liquid crystal display panel unit 101 includes a liquid crystal driver, a control board, and a liquid crystal panel. The liquid crystal panel is a transmissive liquid crystal panel including a plurality of liquid crystal elements. The control board outputs a control signal corresponding to image data to the liquid crystal driver. The liquid crystal driver controls the transmittance of the liquid crystal panel (the transmittance of the liquid crystal elements) according to a control signal. Light from the backlight unit 102 is transmitted through the liquid crystal panel at the transmittance based on the image data input to the liquid crystal panel unit 101, whereby an image is displayed.

The backlight unit 102 is a light emitting unit configured to emit light to the rear surface of the liquid crystal panel unit 101. The backlight unit 102 includes a light source, a control circuit configured to control the light source, and an optical unit configured to diffuse light emitted from the light source. The light emission brightness (light emission luminance) of the light source is controlled by the control circuit. The light emitted from the light source is diffused by the optical unit and irradiated on the rear surface of the liquid crystal panel unit 101. In this embodiment, the backlight unit 102 has a configuration capable of controlling light emission brightness concerning each of a plurality of backlight regions that form a region of a screen. For example, the backlight unit 102 includes a light source capable of individually controlling the light emission brightness of each of the backlight regions. The backlight unit 102 emits light for each backlight region at light emission brightness in accordance with a light emission brightness control value. In this embodiment, the screen is divided into m×n backlight regions in total including m (m is an integer equal to or larger than 1) backlight regions in the horizontal direction n (n is an integer equal to or larger than 1) backlight regions in the vertical direction. Specifically, in this embodiment, m=4 and n=5. In this embodiment, the light emission brightness is higher as a light emission brightness control value is larger.

In this embodiment, a value lower than predetermined light emission brightness is set as the light emission brightness of a backlight region where a dark image is displayed. The transmittance of the liquid crystal panel unit 101 is increased by increasing a pixel value of image data at an increase ratio corresponding to a fall in the light emission brightness. Consequently, it is possible to reduce, without substantially reducing brightness on the screen, floating black due to a leak of light from the backlight unit 102 in a region where a dark image is displayed.

In this embodiment, to facilitate understanding of explanation, it is assumed that a range of pixel values of input image data and a range of pixel values of image data for controlling the transmittance of the liquid crystal panel section 101 are the same. For example, the range of pixel values of input image data is 0 to 255, the transmittance of the liquid crystal panel unit 101 is the smallest when the pixel value is 0, and the transmittance of the liquid crystal panel unit 101 is the largest when the pixel value is 255. In the following explanation, unless specifically noted otherwise, a maximum value in a range of values that the pixel value can take is represented as DMAX.

The characteristic value detecting unit 103 acquires a characteristic value of image data input to the display apparatus (input image data). In this embodiment, the characteristic value detecting unit 103 acquires, for each of image regions obtained by dividing the screen, a characteristic value of an image displayed in the image region. The image region and the backlight region desirably correspond to each other in a one-to-one relation. In this embodiment, a brightness histogram of the image displayed in the image region is acquired as the characteristic value. The histogram is, for example, a histogram of thirty-two categories obtained by dividing, by 32, a range of values that brightness can take (in this embodiment, a range of 0 to 255).

The characteristic value may be detected by analyzing the image or may be input from the outside.

The light emission brightness determining unit 104 causes the backlight unit 102 to emit light. Specifically, the light emission brightness determining unit 104 causes the backlight unit 102 to emit light at light emission brightness based on the characteristic value acquired by the characteristic value detecting unit 103. In this embodiment, the light emission brightness determining unit 104 determines a light emission brightness control value for each of the backlight regions on the basis of the characteristic value of each of the image regions detected by the characteristic value detecting unit 103. In this embodiment, the light emission brightness determining unit 104 determines a light emission brightness control value by reducing, at a reduction ratio based on the characteristic value of each of the image regions, a light emission brightness control value (a standard light emission brightness control value) corresponding to predetermined light emission brightness (standard light emission brightness). The standard light emission brightness is light emission brightness obtained when the light emission brightness of each of the backlight regions is not controlled (light emission brightness obtained when the entire backlight is uniformly caused to emit light).

In order to realize brightness corresponding to a pixel value concerning all pixels, the backlight unit 102 has to be caused to emit light at least at light emission brightness capable of realizing brightness corresponding to a maximum pixel value. However, the light emission brightness determining unit 104 determines light emission brightness to suppress floating black without taking into account whether the brightness corresponding to the maximum pixel value can be realized.

A determining method for light emission brightness (a light emission brightness control value) of each of the backlight regions is explained. It is assumed that the image region and the backlight region correspond to each other in a one-to-one relation.

First, the light emission brightness determining unit 104 converts, for each of the backlight regions, a histogram of the image region into a cumulative histogram in which categories are plotted in order from a category having a largest pixel value.

Subsequently, the light emission brightness determining unit 104 detects, for each of the backlight regions, a maximum pixel value HistH of a category (a range of pixel values) in which a frequency is equal to or higher than a threshold (e.g., equal to or higher than 1% of a total frequency) in the cumulative histogram.

The light emission brightness determining unit 104 calculates, for each of the backlight regions, as a reduction ratio, a value obtained by dividing HistH by DMAX.

The light emission brightness determining unit 104 calculates, for each of the backlight regions, a light emission brightness control value by multiplying the standard light emission brightness control value with the reduction ratio.

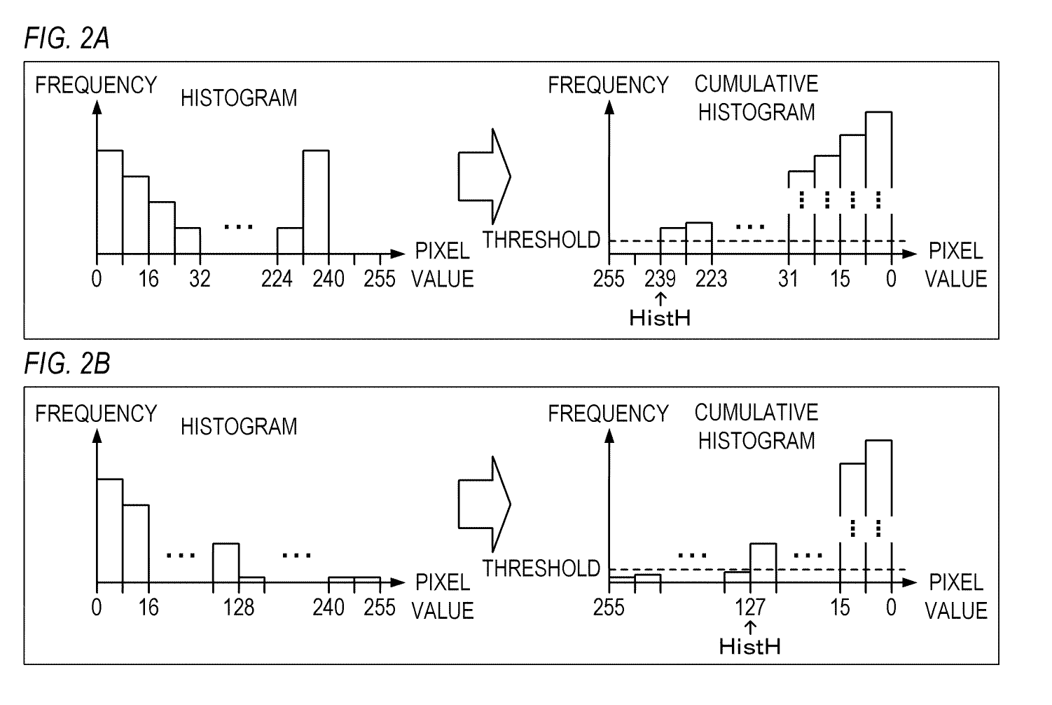

Examples of the histogram and the cumulative histogram are shown in FIGS. 2A and 2B. In the example shown in FIG. 2A, the frequency is equal to or higher than the threshold in categories having high pixel values (categories in which the pixel value is equal to or smaller than 239). Therefore, the reduction ratio is a value close to 1. A value close to the standard light emission brightness control value is obtained as the light emission brightness control value. In the example shown in FIG. 2B, the frequency is not equal to or higher than the threshold in categories having low pixel values (categories in which the pixel value is equal to or smaller than 127). Therefore, the reduction ratio is a small value. A value considerably smaller than the standard light emission brightness control value is obtained as the light emission brightness control value.

In this embodiment, the light emission brightness (the light emission brightness control value) is calculated on the basis of the brightness histogram. However, a determining method for the light emission brightness is not limited to this. For example, the light emission brightness control value may be determined using a table representing a correspondence relation between the characteristic value and the light emission brightness control value without performing a calculation. The light emission brightness control value may be determined using a histogram of a pixel value (an RGB value, etc.). The light emission brightness may be determined from a characteristic value other than the histogram such as an average value, dispersion, a maximum value, a minimum value, a mode, or a median value. A plurality of kinds of values (e.g., maximum brightness and average brightness) may be used as the characteristic value.

Predetermined image processing is applied to input image data by the increase ratio determining unit 105 and the increasing unit 106. Consequently, processed image data is generated. In this embodiment, processing for correcting the input image data according to the light emission brightness of the backlight unit 102 (the light emission brightness control value determined by the light emission brightness determining unit 104) is performed as the predetermined image processing. The input image data is corrected by the predetermined image processing such that the brightness of an image displayed on the screen is equal when the backlight unit 102 is caused to emit light at the standard light emission brightness control value and when the backlight unit 102 is caused to emit light at the light emission brightness control value determined by the light emission brightness determining unit 104.

The increase ratio determining unit 105 determines, for each of the pixels (or for each of the image regions), an increase ratio of a pixel value on the basis of the reduction ratio of the light emission brightness determined by the light emission brightness determining unit 104. For example, the increase ratio determining unit 105 only has to set an inverse of the reduction ratio as the increase ratio in order to set the brightness of an image displayed on the screen same when the backlight unit 102 is caused to emit light at the standard light emission brightness control value and when the backlight unit 102 is caused to emit light at the light emission brightness control value determined by the light emission brightness determining unit 104.

The increasing unit 106 generates processed image data for each of the pixels by increasing the pixel value of the input image data at the increase ratio determined by the increase ratio determining unit 105. The increasing unit 106 outputs the processed image data to the correcting unit 107.

A pixel value of the processed image data is sometimes a value outside a predetermined range (outside a range of pixel values that can be input to the liquid crystal panel unit 101). Specifically, when the pixel value is increased, the pixel value sometimes exceeds DMAX (the maximum value of the pixel value that can be input to the liquid crystal panel unit 101). For example, when DMAX=255, the pixel value of the input image data is 200, and the increase ratio is 1.5, the pixel value of the processed image data is 300 and exceeds DMAX. In the following explanation, a portion of the pixel value exceeding DMAX is represented as saturation amount. In the example explained above, the saturation amount is 45.

The transmittance of the liquid crystal panel unit 101 is the maximum when the pixel value is DMAX and cannot be set higher. Therefore, when the pixel value exceeds DMAX, the brightness on the screen is a value lower than brightness corresponding to the pixel value (brightness is insufficient). In this embodiment, to facilitate the explanation, it is assumed that the brightness on the screen linearly changes with respect to a change in the pixel value. Therefore, the brightness is insufficient by an amount proportional to a product of the saturation amount and the light emission brightness of the backlight unit 102.

The correcting unit 107 generates limited image data by limiting a pixel value outside the predetermined range (a pixel value larger than DMAX) among pixel values of the processed image data to a value within the predetermined range. In this embodiment, the correcting unit 107 generates the limited image data by limiting the pixel value such that a hue represented by the pixel value before the limitation is kept. In this embodiment, the pixel value includes three color signals of RGB (an R value, a G value, and a B value). The correcting unit 107 limits the pixel value such that a ratio (a color balance) of the R value, the G value, and the B value is kept. A pixel, a pixel value of which is limited when the limited image data is generated, is referred to as “limited pixel”.

The correcting unit 107 generates compensated image data (suppressed image data) from the limited image data by adjusting pixel values of pixels around the limited pixel such that a change in the brightness of the limited pixel due to the limitation of the pixel value is compensated (suppressed). Specifically, the pixel value of the limited pixel is reduced to be equal to or smaller than DMAX by limiting the pixel value and the brightness of the limited pixel falls. Therefore, the correcting unit 107 increases the pixel values of the pixels around the limited pixel such that the fall in the brightness is compensated. In this embodiment, the correcting unit 107 determines an adjustment amount such that a hue represented by an adjustment amount for pixel values given to pixels around the limited pixel in order to compensate a change in the brightness of one limited pixel coincides with a hue represented by a pixel value before limitation of the limited pixel.

The correcting unit 107 outputs compensated image data to the liquid crystal panel unit 101.

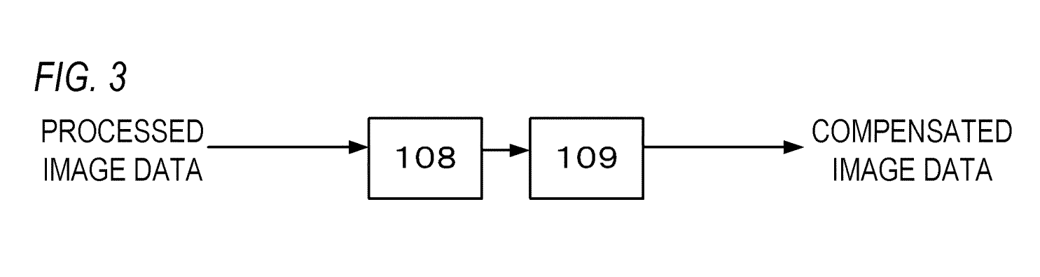

An example of a functional configuration of the correcting unit 107 is shown in FIG. 3.

The correcting unit 107 includes a limiting unit 108 and a compensating unit (a suppressing unit) 109.

The limiting unit 108 generates limited image data by limiting a pixel value outside the predetermined range (a pixel value larger than DMAX) among pixel values of the processed image data to a value within the predetermined range. The limiting unit 108 outputs a limited amount signal representing limited amounts of the pixels (a signal obtained by subtracting the limited image data from the processed image data) and the limited image data.

The compensating unit 109 generates compensated image data (suppressed image data) from the limited image data by adjusting pixel values of pixels around a limited pixel such that a change in the brightness of the limited pixel due to the limitation of the pixel value by the limiting unit 108 is compensated (suppressed) and outputs the compensated image data.

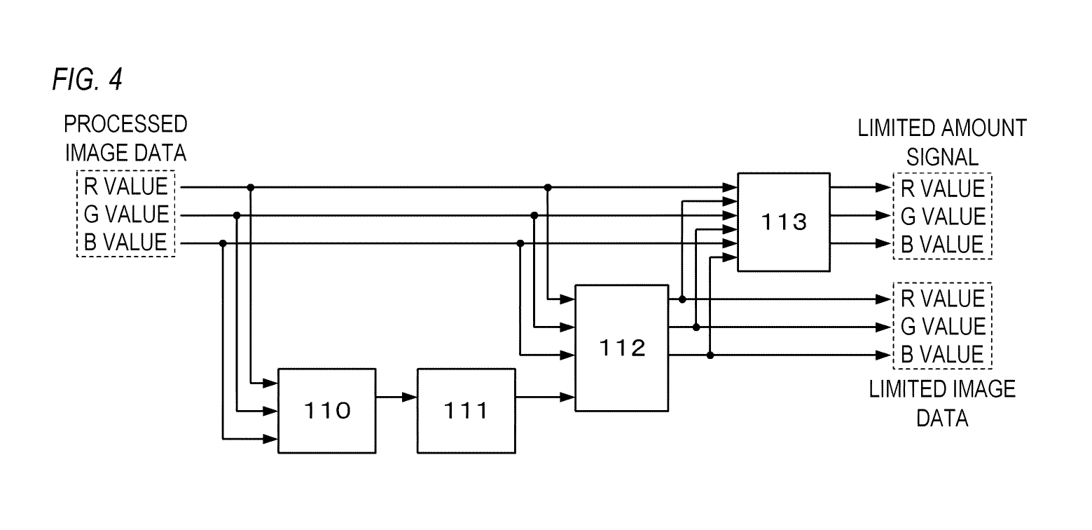

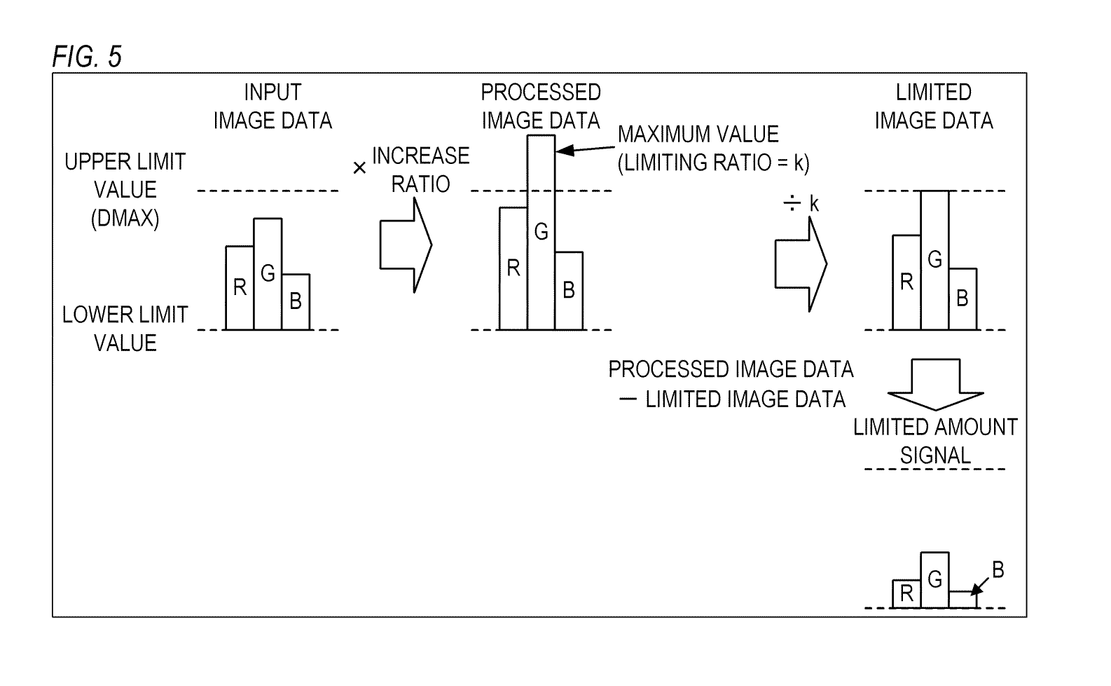

FIG. 4 shows an example of a functional configuration of the limiting unit 108. FIG. 5 shows an example of processing of the limiting unit 108.

The limiting unit 108 includes a maximum value detecting unit 110, a limiting ratio determining unit 111, a division unit 112, and a subtraction unit 113.

The maximum value detecting unit 110 detects, for each of the pixels, a maximum value from the R value, the G value, and the B value included in the pixel value of the processed image data. The maximum value detecting unit 110 outputs a maximum value of each of the pixels.

The limiting ratio determining unit 111 calculates, for each of the pixels, as a limiting ratio, a ratio of the maximum value detected by the maximum value detecting unit 110 to DMAX. However, when the ratio of the maximum value detected by the maximum value detecting unit 110 to DMAX is equal to or smaller than 1, the limiting ratio is set to 1. The limiting ratio determining unit 111 outputs a limiting ratio for each of the pixels.

For example, when the R value, the G value, and the B value are respectively 220, 384, and 128, 384 is detected as the maximum value. When DMAX=255, the limiting ratio is a value (about 1.5) obtained by dividing 255 by 384.

The division unit 112 calculates, for each of the pixels, a pixel value of the limited image data by dividing the R value, the G value, and the B value included in the pixel value of the processed image data by the limiting ratio. The division unit 112 outputs the limited image data (image data, pixel values of which are values obtained by dividing the pixel value of the processed image data by the limiting ratio).

The subtraction unit 113 calculates a value (a pixel value) of the limited amount signal by subtracting the pixel value of the limited image data from the pixel value of the processed image data. The subtraction unit 113 outputs the limited amount signal (image data, pixel values of which are values obtained by subtracting the pixel value of the limited image data from the pixel value of the processed image data).

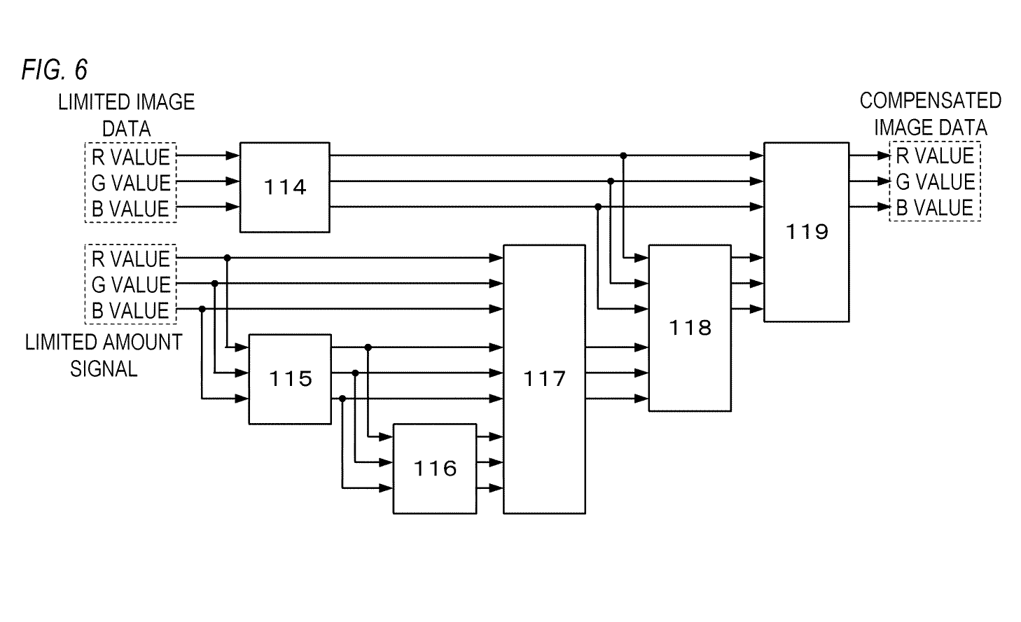

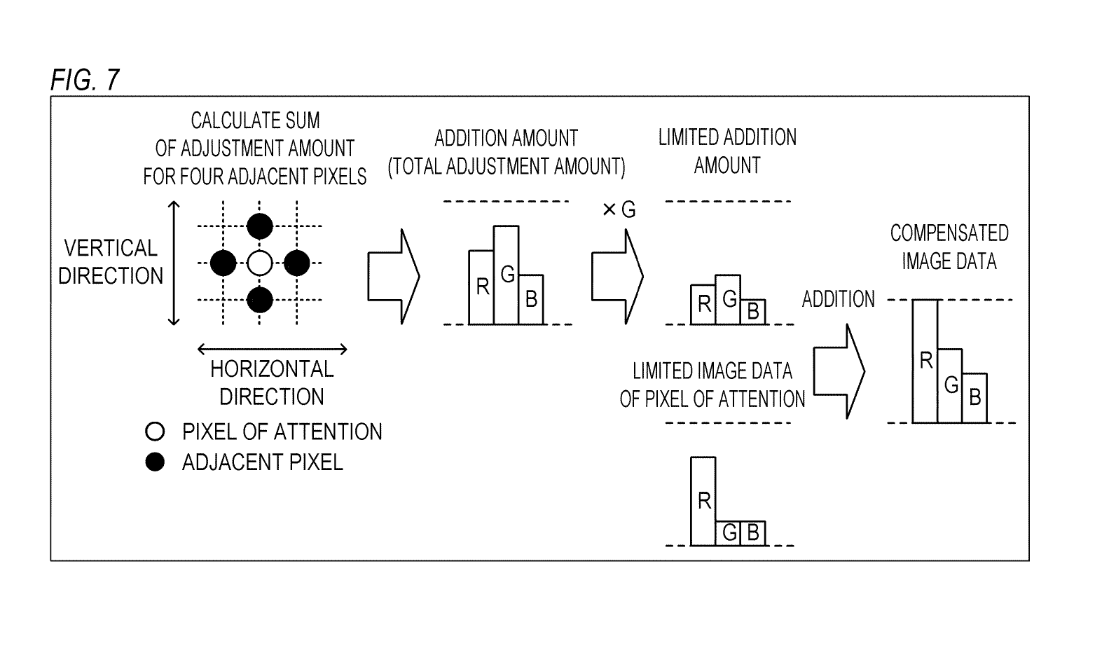

FIG. 6 shows an example of a functional configuration of the compensating unit 109. FIG. 7 shows an example of processing of the compensating unit 109.

The compensating unit 109 includes a line delay unit a 114, a line delay unit b 115, a line delay unit c 116, an addition amount determining unit 117, an addition amount limiting unit 118, and an addition unit 119.

Each of the line delay unit a 114, the line delay unit b 115, and the line delay unit c 116 delays input image data by one line and outputs the image data.

The limited image data is input to the line delay unit a 114. The line delay unit a 114 outputs the limited image data delayed by one line as one-line delayed limited image data.

The limited amount signal is input to the line delay unit b 115. The line delay unit b 115 outputs the limited amount signal delayed by one line as one-line delayed limited amount signal.

The one-line delayed limited amount signal is input to the line delay unit c 116. The line delay unit c 116 outputs the limited amount signal delayed by two lines as two-line delayed limited amount signal.

The addition amount determining unit 117 determines an adjustment amount for a pixel value. As explained above, in this embodiment, the adjustment amount is determined such that a hue represented by an adjustment amount for pixel values given to pixels around the limited pixel in order to compensate a change in the brightness of one limited pixel coincides with a hue represented by a pixel value before limitation of the limited pixel. In this embodiment, in causing a plurality of pixels to compensate a change in the brightness of one limited pixel, adjustment amounts for pixel values of the plurality of pixels are determined such that the adjustment amounts for the pixel values are equal to one another among the pixels.

In this embodiment, a pixel value of one pixel of attention is adjusted, whereby a change in the brightness of four pixels adjacent to the upper, lower, left, and right sides of the pixel of attention is compensated.

The addition amount determining unit 117 determines, for each of the pixels, with the pixel set as an adjustment target pixel (a pixel of attention), four adjustment amounts for compensating a change in the brightness of four pixels (adjacent pixels) adjacent to the upper, lower, left, and right sides of the pixel of attention. In this embodiment, a pixel of the one-line delayed limited amount signal is set as a pixel of attention. Pixels of the one-line delayed limited amount signal are set as pixels adjacent to the left and right sides of the pixel of attention. A pixel of the two-line delayed limited amount signal is set as a pixel adjacent to the lower side of the pixel of attention. In this embodiment, a change in the brightness of one limited pixel is compensated by the four pixels. Therefore, a quarter of a saturation amount (a value of a limited amount signal) of one limited pixel is set as an adjustment amount for the pixel of attention for compensating for the change in the brightness of the limited pixel.

The addition amount determining unit 117 calculates, for the pixel of attention, a sum (a total adjustment amount) of the four adjustment amounts as an addition amount. The addition amount determining unit 117 outputs an addition amount for each of the pixels.

When a pixel, a pixel value of which after adjustment is a value outside the predetermined range, is present, the addition amount limiting unit 118 limits a total adjustment amount for a pixel value of the pixel such that the pixel value after the adjustment of the pixel is a value within the predetermined range. Specifically, the addition amount limiting unit 118 determines, for each of the pixels of the one-line delayed limited image data, whether a pixel value obtained by adding the addition amount determined by the addition amount determining unit 117 to the pixel value of the pixel is a value larger than DMAX. When the pixel value after the addition of the addition amount is a value larger than DMAX, the addition-amount limiting unit 118 limits the addition amount such that the pixel value after the addition of the addition amount is equal to or smaller than DMAX (limitation processing). The addition amount limiting unit 118 outputs the addition amount after the limitation processing for each of the pixels (a limited addition amount).

In this embodiment, the total adjustment amount is limited such that a hue represented by the total adjustment amount after the adjustment coincides with a hue represented by the total adjustment amount before the adjustment. Specifically, the addition amount limiting unit 118 calculates a gain G of the addition amount. The addition amount limiting unit 118 calculates a limited addition amount by multiplying the R value, the G value, and the B value included in the addition amount with the gain G.

The gain G is calculated by, for example, a method explained below.

First, a maximum amount GMR of a gain of the R value included in the addition amount, a maximum value GMG of a gain of the G value included in the addition amount, and a maximum value GMB of a gain of the B value included in the addition amount are calculated using Expressions 1-1 to 1-3. In Expressions 1-1 to 1-3, DMAX represents a maximum value of a pixel value that can be input to the liquid crystal panel unit 101. DR, DG, and DB represent the R value, the G value, and the B value included in the pixel value of the limited image data. OVR, OVG, and OVB represent the R value, the G value, and the B value included in the addition amount.

GMR=(DMAX−DR)/OVR (1-1)

GMG=(DMAX−DG)/OVG (1-2)

GMB=(DMAX−DB)/OVB (1-3)

A minimum value among the gain GMR, the gain GMG, and the gain GMB is set as the gain G. When all of the gain GMR, the gain GMG, and the gain GMB are equal to or larger than 1, 1 is set as the gain G.

The addition unit 119 adds, for each of the pixels of the one-line delayed limited image data, a limited addition amount to a pixel value of the pixel. Consequently, compensated image data is generated. The addition unit 119 outputs the generated compensated image data to the liquid crystal panel unit 101.

As explained above, according to this embodiment, pixel values of pixels around the limited pixel are adjusted such that a change in the brightness of the limited pixel due to the limitation of the pixel value is compensated. Consequently, it is possible to suppress deterioration in image quality caused by limiting a pixel value outside the predetermined range to a value within the predetermined range. Specifically, a fall in the brightness due to the reduction of the pixel value is compensated by the pixels around the limited pixel. Therefore, it is possible to suppress a fall in ocular brightness.

According to this embodiment, processing is performed such that a hue represented by an adjustment amount given to a pixel to compensate a change in brightness coincides with a hue of a pixel value before limitation. Consequently, it is possible to further suppress deterioration in image quality caused by limiting a pixel value outside the predetermined range to a value within the predetermined range. Specifically, it is possible to suppress a change in a color due to the limitation of the pixel value and a change in a color due to the compensation of the brightness.

According to this embodiment, when a pixel, a pixel value of which after adjustment is a value outside the predetermined range, is present, a total adjustment amount for a pixel value of the pixel is limited such that the pixel value after the adjustment of the pixel is a value within the predetermined range. Specifically, the total adjustment amount is adjusted such that a hue represented by the total adjustment amount after adjustment coincides with a hue represented by the total adjustment amount before the adjustment. Consequently, it is possible to further suppress deterioration in image quality caused by limiting a pixel value outside the predetermined range to a value within the predetermined range. Specifically, even when the pixel value after the adjustment is a value outside the predetermined range, it is possible to suppress a change in a color due to compensation of brightness.

According to this embodiment, in causing a plurality of pixels to compensate a change in the brightness of one limited pixel, adjustment amounts for pixel values of the plurality of pixels are determined such that adjustment amounts for pixel values are equal to one another among the plurality of pixels. Consequently, it is possible to suppress occurrence of brightness unevenness due to the compensation.

In the example explained in this embodiment, when a pixel value exceeds the upper limit value, the pixel value is limited to the upper limit value. However, the pixel value is not limited to this. The pixel value after the limitation only has to be a value within the predetermined range (a range of values that the pixel value can take) and may be a value smaller than the upper limit value.

In this embodiment, the pixel value exceeds the upper limit value of the predetermined range (the range of values that the pixel value can take). However, the pixel value is not limited to this. When the pixel value falls below a lower limit value of the predetermined range, the pixel value is sometimes limited to a value equal to or larger than the lower limit value. In that case, a change in brightness due to the limitation of the pixel value fallen below the lower limit value may be compensated by the same method. However, when the change in the brightness due to the limitation of the pixel value fallen below the lower limit value is compensated, it is likely that floating black occurs. Therefore, only a change in brightness due to limitation of the pixel value exceeding the upper limit value may be compensated with priority given to suppression of floating black.

In the example explained in this embodiment, the four pixels adjacent to the upper, lower, left, and right sides of the limited pixel are pixels around the limited pixel. However, the pixels around the limited pixel are not limited to the four pixels. For example, eight pixels in total, i.e., two pixels adjacent to the upper side of the limited pixel, two pixels adjacent to the lower side of the limited pixel, two pixels adjacent to the left side of the limited pixel, and two pixels adjacent to the right side of the limited pixel may be the pixels around the limited pixel. Eight pixels adjacent to the upper, lower, left, right, upper left, upper right, lower left, and lower right sides of the limited pixel may be set as the pixels around the limited pixel.

In the example explained in this embodiment, the transmittance (the brightness on the screen) linearly increases with respect to an increase in the pixel value. However, the increase in the transmittance is not limited to this. For example, the transmittance (the brightness on the screen) may increase exponentially with respect to an increase in the pixel value. In that case, for example, it is possible to calculate (estimate) a change in brightness due to limitation of the pixel value using a function representing a change in the transmittance with respect to the pixel value. It is possible to calculate a compensation amount for compensating the change in the brightness from the function and a pixel value of an adjustment target pixel (a pixel value of the limited image data).

When the pixel of attention is the limited pixel, there is little room for adding an addition amount. Therefore, the pixel of attention does not have to be selected as the adjustment target pixel. In this embodiment, four pixels adjacent to the upper, lower, left, and right sides of the limited pixel are caused to compensate a change in the brightness of one limited pixel. However, the brightness of one limited pixel is not always compensated by the four pixels. For example, when pixel values of two pixels among the four pixels are DMAX, a change in the brightness of the limited pixel can be compensated by only the remaining two pixels. Therefore, in such a case, it is preferable to cause the two pixels to compensate, by halves, a change in the brightness of the limited pixel. That is, it is preferable to determine a compensation amount on the basis of the number of limited pixels (the number of pixels other than the limited pixel) present around the limited pixel.

In this embodiment, light emission brightness and a pixel value are adjusted for each of backlight regions. However, adjustment of the light emission brightness and the pixel value is not limited to this. The light emission brightness of the entire backlight may be controlled on the basis of the lightness of an entire image and pixel values may be adjusted on the basis of the light emission brightness of the entire backlight.

In the example explained in this embodiment, the display apparatus is the liquid crystal display apparatus. However, the display apparatus is not limited to the liquid crystal display apparatus. The display apparatus only has to be a display apparatus including a backlight unit and a display unit configured to transmit light from the backlight unit and display an image.

In causing a plurality of pixels to compensate a change in the brightness of one limited pixel, an adjustment amount for a pixel value may be different among the plurality of pixels. Even in such a case, effects equivalent to the effects explained above can be obtained.

A hue of a pixel value after limitation and a hue represented by an adjustment amount given to the pixels in order to compensate a change in brightness do not have to coincide with a hue of the pixel value before the limitation. A hue represented by a total adjustment amount after adjustment does not have to coincide with a hue represented by the total adjustment amount before the adjustment. Even in such a case, if a change in the brightness of the limited image due to the limitation of the pixel value is compensated, it is possible to suppress deterioration in image quality due to the change in the brightness.

### Second Embodiment

A display apparatus and a control method for the display apparatus according to a second embodiment of the present invention are explained below with reference to the drawings.

In the first embodiment, a saturation amount of all the limited pixels is compensated. When a pixel value of a region having a large area is limited, a large number of limited pixels are present around the pixel of attention. Therefore, an addition amount of the pixel of attention increases and the gain G decreases. Therefore, when the pixel value of the region having a large area is limited, an effect of the present invention (an effect of suppressing deterioration in image quality) decreases. Moreover, when the pixel value of the region having a large area is limited, a color of a large number of limited pixels is added to a color of the pixel of attention. Therefore, it is likely that details of an image are lost (image quality is deteriorated). The limited pixel is a pixel, a pixel value of which is limited when limited image data is generated and the pixel value changes to a value outside the predetermined range when the predetermined image processing is applied to input image data.

On the other hand, when a change in the brightness of locally present limited pixels (isolated limited pixels) is compensated, the gain G is a value close to 1. Therefore, a high effect can be obtained as an effect of the present invention.

Therefore, in this embodiment, a pixel value of the limited pixel among pixel values of processed image data is limited to a value within the predetermined range and pixel values of pixels around the isolated limited pixels are adjusted such that a change in brightness due to limitation of pixel values of the isolated limited pixels is compensated. The processed image data is image data generated by applying the predetermined image processing to the input image data.

In this embodiment, a change in the brightness of only the isolated limited pixels, with which a high effect can be obtained, is compensated. Therefore, a high effect can be obtained.

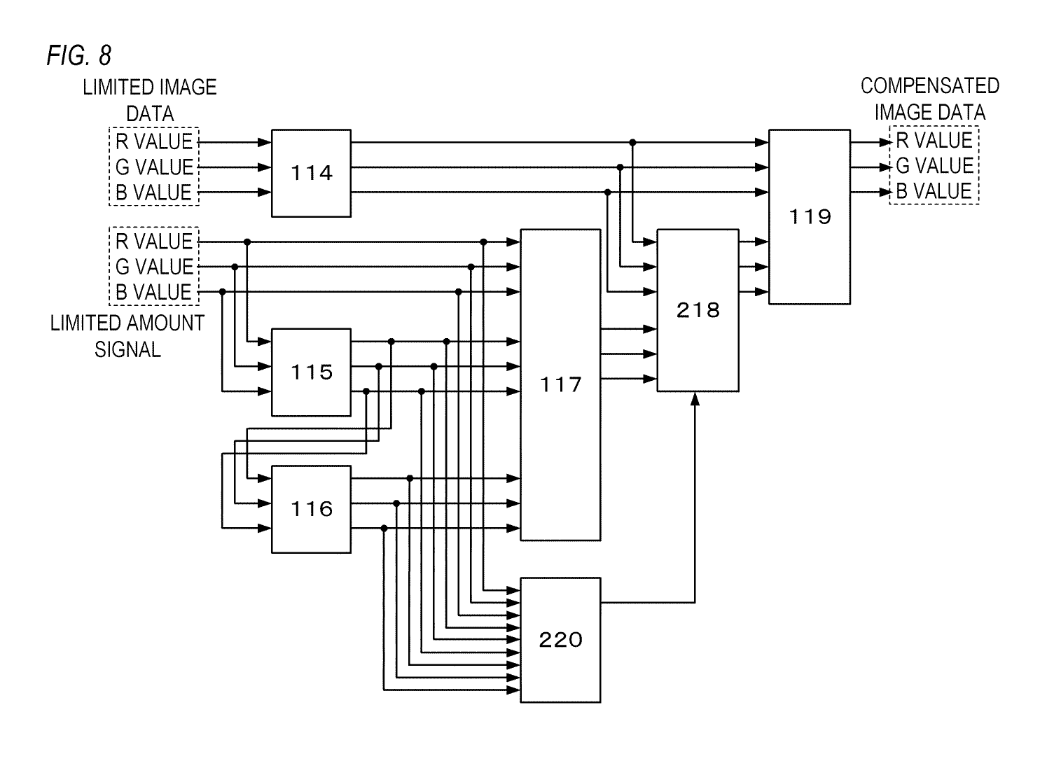

FIG. 8 shows an example of a functional configuration of a compensating unit according to the second embodiment.

The compensating unit according to this embodiment includes the line delay unit a 114, the line delay unit b 115, the line delay unit c 116, the addition amount determining unit 117, an addition amount limiting unit 218, the addition unit 119, and an addition amount control unit 220.

The operations of the line delay unit a 114, the line delay unit b 115, the line delay unit c 116, the addition amount determining unit 117, and the addition unit 119 are the same as the operations in the first embodiment.

The addition amount control unit 220 determines whether the limited pixels are the isolated limited pixels such that a change in the brightness of the limited pixels other than the isolated limited pixels is not compensated. It is possible to determine on the basis of an arrangement of the limited pixels whether the limited pixels are the isolated limited pixels.

When the number of limited pixels present around the pixel of attention is larger than a predetermined number, it is less likely that the limited pixels are the isolated limited pixels. Therefore, in this embodiment, when the number of limited pixels present around one pixel (the pixel of attention) is equal to or smaller than the predetermined number, the addition amount control unit 220 determines that the limited pixels are the isolated limited pixels. Specifically, when three or more pixels among four pixels adjacent to the upper, lower, left, and right sides of the pixel of attention are limited pixels, the addition amount control unit 220 determines that the limited pixels are not the isolated limited pixels. When two or less pixels among the four pixels adjacent to the upper, lower, left, and right sides of the pixel of attention are limited pixels, the addition amount control unit 220 determines that the limited pixels are the isolated limited pixels. When the limited pixels around the pixel of attention are the isolated limited pixels, the addition amount control unit 220 outputs 0 as a control signal. When the limited pixels around the pixel of attention are not the isolated limited pixels, the addition amount control unit 220 outputs 1 as a control signal.

Like the addition amount limiting unit 118 explained in the first embodiment, the addition amount limiting unit 218 calculates a limited addition amount. However, when the control signal is 1, the addition amount limiting unit 118 replaces the limited addition amount with 0. Since the limited addition amount is replaced with 0 in this way, the addition unit 119 adjusts pixel values of the pixels around the isolated limited pixels such that a change in brightness due to the limitation of the pixel values of the isolated limited pixels is compensated.

As explained above, according to this embodiment, the pixel values of the pixels around the isolated limited pixels are adjusted such that a change in brightness due to the limitation of the pixel values of the isolated limited pixels is compensated. Consequently, a high effect can be obtained as an effect of suppressing deterioration in image quality. Specifically, it is possible to suppress a situation in which a pixel value of an unintended pixel is adjusted and image quality is deteriorated.

A detecting method for the isolated limited pixels is not limited to the method explained above. For example, when a region including only limited pixels is detected and the size of the region is equal to or smaller than a predetermined value, it may be determined that the region is a region including the isolated limited pixels. When a predetermined number (e.g., two) or more pixels having pixel values lower than a pixel value of a limited pixel by a predetermined value or more are present among pixels adjacent to the limited pixel, it may be determined that the limited pixel is the isolated limited pixel.

### Third Embodiment

A display apparatus and a control method for the display apparatus according to a third embodiment of the present invention are explained below with reference to the drawings. In the first embodiment, when the pixel value cannot be adjusted according to the total adjustment amount, specifically, when the pixel value exceeds DMAX because of the addition amount, the addition amount is limited according to the gain G. When limited pixels around a pixel of attention are isolated limited pixels, it is highly likely that the gain G is a value close to 1. However, when the limited pixels around the pixel of attention are not the isolated limited pixels, it is highly likely that the gain G is a small value far from 1. When the gain G is closer to 1, a change in brightness due to limitation of the addition amount (an adjustment amount) is small and a change in the brightness of the limited pixels is sufficiently compensated. Therefore, a high effect can be obtained as the effect of the present invention (the effect of suppressing deterioration in image quality). However, when the gain G is the value far from 1, a change (a fall) in the brightness due to the limitation of the addition amount (the adjustment amount) is large and a change in the brightness of the limited pixels is not sufficiently compensated. Therefore, a high effect cannot be obtained as the effect of the present invention.

A change in brightness due to the limitation of the adjustment amount can be compensated by, for example, controlling the light emission brightness of a backlight unit.

Therefore, in this embodiment, the light emission brightness of the backlight unit is controlled such that a change in brightness due to limitation of a total adjustment amount is compensated. Specifically, for each of backlight regions (each of image regions), a reduction ratio determined by the light emission brightness determining unit 104 is corrected on the basis of the gains G of pixels in the region. Consequently, even when the gain G is a small value far from 1, a high effect can be obtained as the effect of suppressing deterioration in image quality.

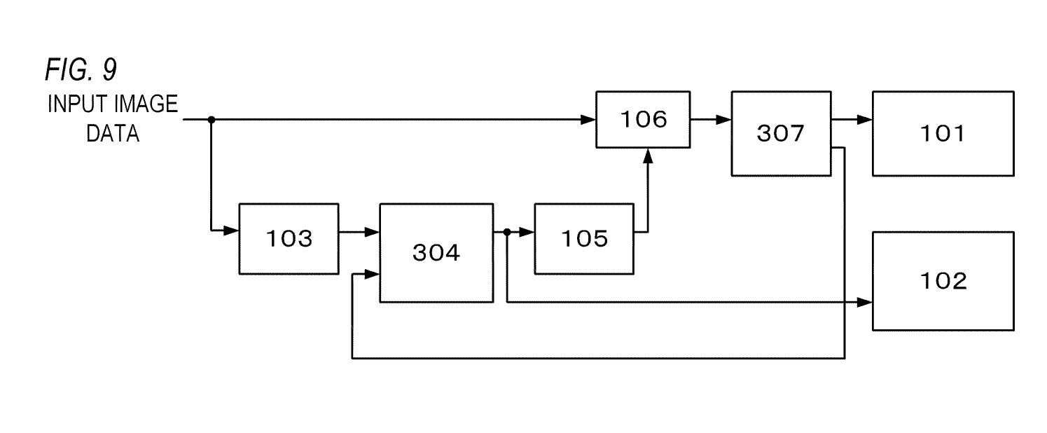

FIG. 9 is a diagram showing an example of a functional configuration example of the display apparatus according to this embodiment.

The display apparatus according to this embodiment includes the liquid crystal panel unit 101, the backlight unit 102, the characteristic value detecting unit 103, a light emission brightness determining unit 304, the increase ratio determining unit 105, the increasing unit 106, and a correcting unit 307.

The operations of the liquid crystal panel unit 101, the backlight unit 102, the characteristic value detecting unit 103, the increase ratio determining unit 105, and the increasing unit 106 are the same as the operations in the first embodiment.

Like the correcting unit 107 explained in the first embodiment, the correcting unit 307 generates and outputs compensated image data. The correcting unit 307 generates and outputs a light emission brightness correction signal for correcting light emission brightness.

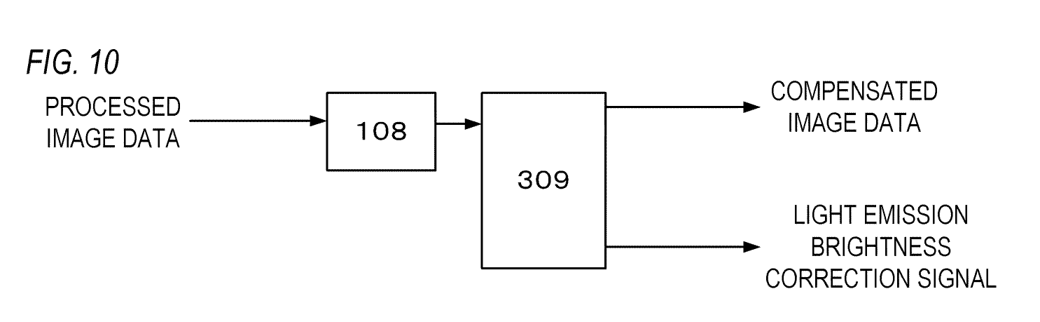

An example of a functional configuration of the correcting unit 307 is shown in FIG. 10.

The correcting unit 307 includes the limiting unit 108 and a compensating unit 309.

The operation of the limiting unit 108 is the same as the operation in the first embodiment.

Like the compensating unit 109 explained in the first embodiment, the compensating unit 309 generates and outputs compensated image data. The compensating unit 309 determines, for each of the backlight regions, on the basis of total measurement information representing the gains G of pixels in the region, whether light emission brightness of the region is insufficient (whether a change in the brightness of a limited pixel is sufficiently compensated). The compensating unit 309 generates, on the basis of a result of the determination, a light emission brightness correction signal for correcting light emission brightness of each of the backlight regions and outputs the light emission brightness correction signal.

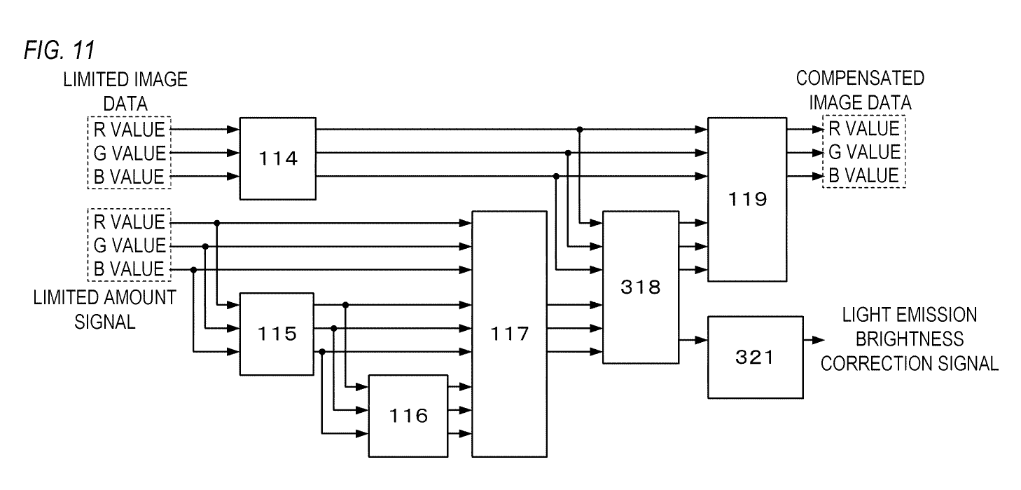

An example of a functional configuration of the compensating unit 309 is shown in FIG. 11.

The compensating unit 309 includes the line delay unit a 114, the line delay unit b 115, the line delay unit c 116, the addition amount determining unit 117, an addition amount limiting unit 318, the addition unit 119, and a light emission brightness correction determining unit 321.

The operations of the line delay unit a 114, the line delay unit b 115, the line delay unit c 116, the addition amount determining unit 117, and the addition unit 119 are the same as the operations in the first embodiment.

A basic operation of the addition amount limiting unit 318 is the same as the basic operation of the addition amount limiting unit 118 explained in the first embodiment. However, the addition amount limiting unit 318 further performs processing for outputting the gains G of the pixels.

The light emission brightness correction determining unit 321 calculates, for each of the backlight regions, an average value (an average gain) of the gains G of the pixels in the region. The light emission brightness correction determining unit 321 determines, for each of the backlight regions, whether the average gain is larger than a predetermined value. The light emission brightness correction determining unit 321 generates a light emission brightness correction signal in which 0 is set for the backlight region having the average gain smaller than the predetermined value and 1 is set for the backlight region having the average gain larger than the predetermined value and outputs the light emission brightness correction signal. The predetermined value is determined on the basis of to which degree a change in brightness due to cut-off of an addition amount (a total adjustment amount), i.e., limitation of a pixel value is allowed. For example, when cut-off of an addition amount (a total adjustment amount) of 5% is allowed, 0.95 is used as the predetermined value.

The light emission brightness determining unit 304 controls the light emission brightness of the backlight unit 102 such that a change in brightness due to limitation of the addition amount (the total adjustment amount) is limited. In this embodiment, like the light emission brightness determining unit 104 explained in the first embodiment, the light emission brightness determining unit 304 calculates a reduction ratio for each of the backlight regions. The light emission brightness determining unit 304 corrects the reduction ratio for each of the backlight regions on the basis of a light emission brightness correction signal output from the compensating unit 309.

Processing of the light emission brightness determining unit 304 is specifically explained below.

First, the light emission brightness determining unit 304 performs, for each of frames and for each of the backlight regions, count processing corresponding to a value of the light emission brightness correction signal. When the value of the light emission brightness correction signal is 1, the light emission brightness determining unit 304 counts up a correction value by 1. When the value of the light emission brightness correction signal is 0, the light emission brightness determining unit 304 counts down the correction value by 1. An initial value and a lower limit value of the correction value are 0.

The light emission brightness determining unit 304 multiplies, for each of the backlight regions, the correction value with a predetermined constant KT and adds a multiplied value to the reduction ratio. When the constant KT is 0.002, the reduction ratio increases by 0.1 when the value of the light emission brightness correction signal is 1 in a period of fifty frames. In this way, in the backlight region where 1 is output as the light emission brightness correction signal, the reduction ratio gradually increases and the light emission brightness also gradually increases. When the light emission brightness reaches a sufficient value and the average gain is larger than the threshold, 0 is output as the light emission brightness correction signal and light emission brightness is fixed.

The light emission brightness control value may be corrected rather than the reduction ratio.

As explained above, according to this embodiment, the light emission brightness of the backlight unit is controlled such that a change in the brightness due to the limitation of the total adjustment amount is compensated. Consequently, a high effect can be obtained as the effect of suppressing deterioration in image quality. Specifically, when a change in the brightness due to the limitation of the pixel value cannot be sufficiently compensated, it is possible to sufficiently compensate a change in the brightness by controlling the light emission brightness of the backlight.

The configuration of this embodiment (the configuration for controlling the light emission brightness of the backlight unit such that a change in the brightness due to the limitation of the total adjustment amount is compensated) can be applied to the configuration in the second embodiment.

### Fourth Embodiment

A display apparatus and a control method for the display apparatus according to a fourth embodiment of the present invention are explained below with reference to the drawings. In this embodiment, a configuration for enabling, even when a change in brightness due to limitation of a pixel value cannot be sufficiently compensated, sufficient compensation of the change in the brightness according to a method different from the method in the third embodiment is explained. The configuration in this embodiment can be applied to the configuration in the third embodiment as well.

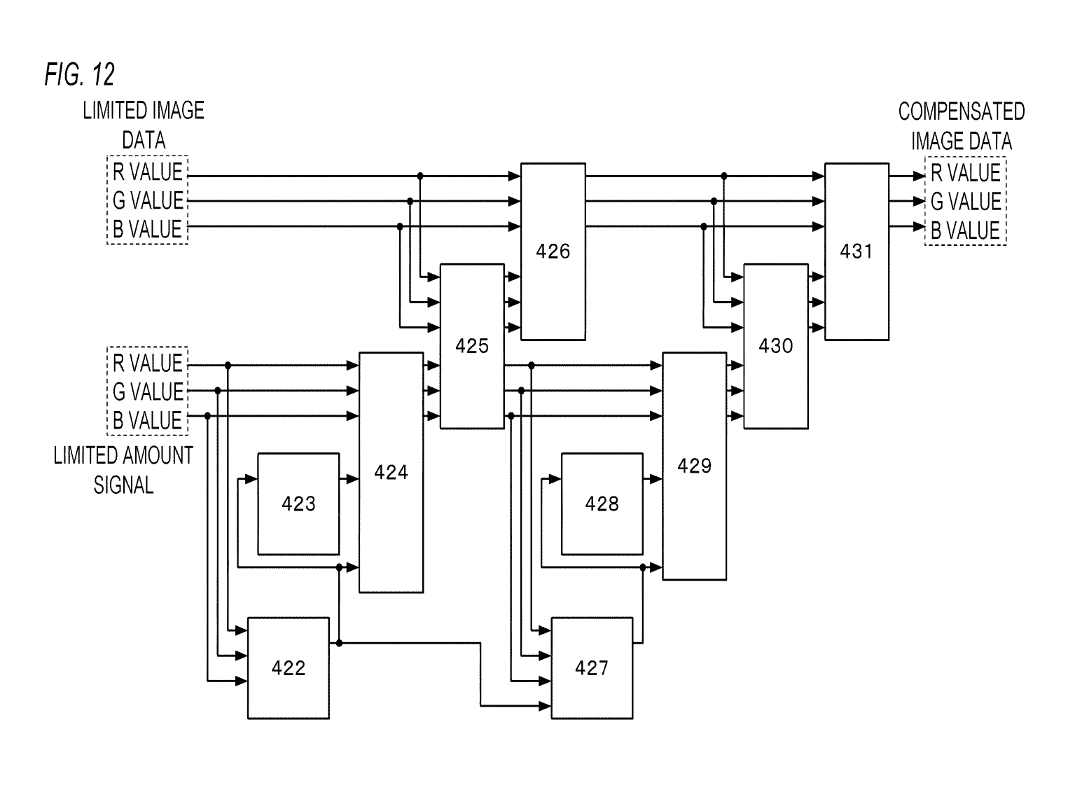

FIG. 12 is a diagram showing an example of a functional configuration of a compensating unit according to this embodiment.

The compensating unit according to this embodiment adjusts pixel values of pixels around a total adjustment amount limited pixel, which is a pixel limited in a total adjustment amount such that a change in brightness due to limitation of the total adjustment amount for the total adjustment amount limited pixel is compensated.

The compensating unit includes a first limited pixel detecting unit 422, a first distribution coefficient determining unit 423, a first addition amount determining unit 424, a first addition amount limiting unit 425, a first addition unit 426, a second limited pixel detecting unit 427, a second distribution coefficient determining unit 428, a second addition amount determining unit 429, a second addition amount limiting unit 430, and a second addition unit 431. The line delay units explained in the first embodiment are omitted.

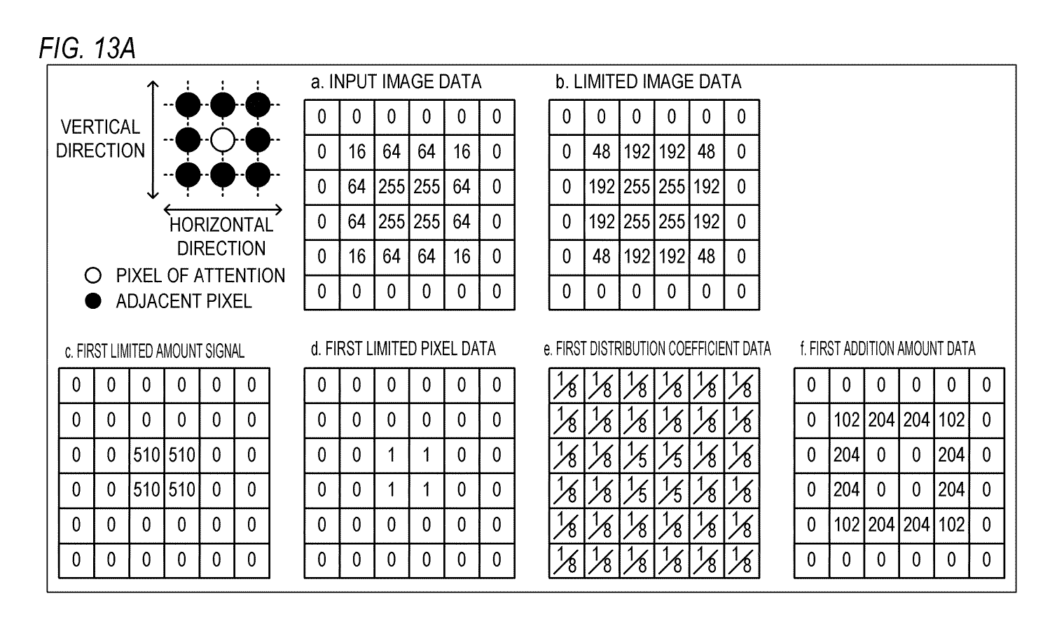

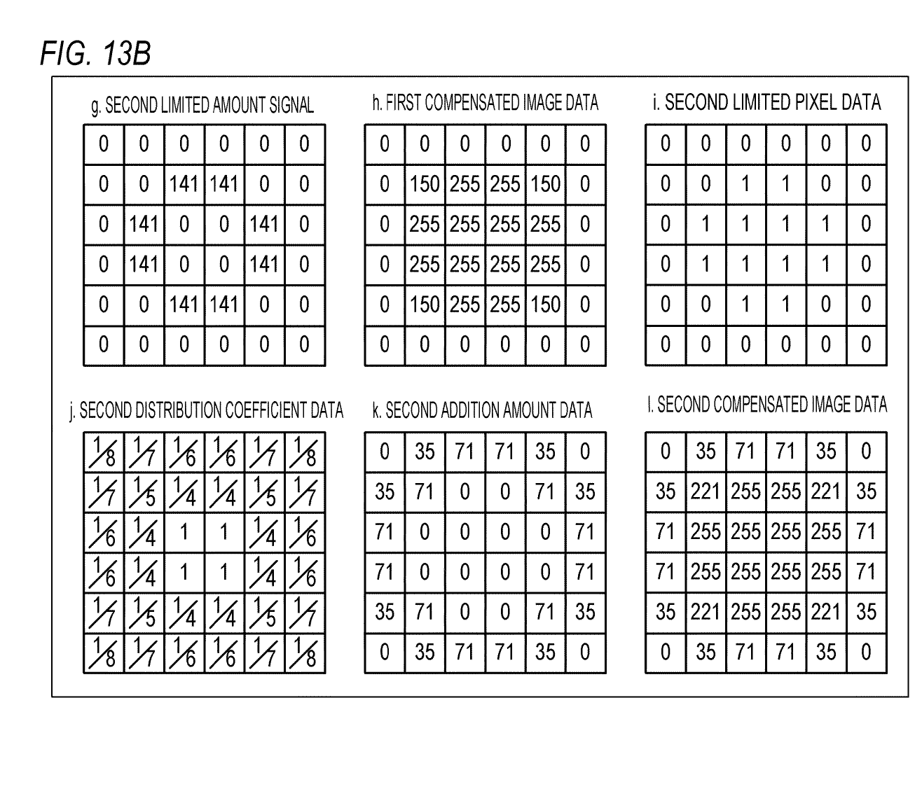

In the first embodiment, a change in the brightness of the limited pixel is compensated by the four pixels adjacent to the upper, lower, left, and right sides of the limited pixel. In this embodiment, a change in the brightness of the limited pixel is compensated by eight pixels adjacent to the upper, lower, left, right, upper left, upper right, lower left, and lower right sides of the limited pixel. That is, as shown in FIGS. 13A and 13B, a change in the brightness of the eight pixels adjacent to the upper, lower, left, right, upper left, upper right, lower left, and lower right sides of the pixel of attention (eight adjacent pixels) is compensated by one pixel of attention.

In FIG. 13A, “a” indicates an example of input image data input to the display apparatus. In FIGS. 13A and 13B, to facilitate understanding of a change in a pixel value (an adjustment method for the pixel value), attention is paid to one of three values, i.e., the R value, the G value, and the B value. The remaining two values are smaller than the value of attention.

When it is assumed that the increase ratio is 3 and DMAX is 255, limited image data indicated by a sign “b” and a limited amount signal (a first limited amount signal) indicated by a sign “c” are obtained.

The first limited pixel detecting unit 422 detects limited pixels on the basis of a first limited amount signal and outputs a detection result as first limited pixel data. Specifically, the first limited pixel detecting unit 422 detects pixels, values of the first limited amount signal of which are not 0, as the limited pixels. The first limited pixel detecting unit 422 generates and outputs first limited pixel data in which 1 is allocated to the limited pixels and 0 is allocated to the other pixels. The first limited pixel data indicated by a sign “d” is obtained from the first limited amount signal indicated by the sign “c”.

The first distribution coefficient determining unit 423 calculates a first distribution coefficient on the basis of the first limited pixel data. A distribution coefficient indicates a ratio of a saturation amount distributed to pixels around the limited pixels. For example, when a distribution coefficient of a pixel is ⅕, ⅕ of a saturation amount of the pixel is distributed to the pixels around the limited pixels. That is, when the pixel value of the pixel of attention is adjusted such that a saturation amount of the limited pixel, the distribution coefficient of which is ⅕, is compensated, ⅕ of the saturation amount of the limited pixels is an adjustment amount for the pixel value of the pixel of attention. The first distribution coefficient determining unit 423 sets, for each of the pixels, as a first distribution coefficient, an inverse of the number of pixels other than the limited pixels (pixels, values of the first limited pixel data of which are 0) among pixels around the pixel (eight adjacent pixels). However, when the number of pixels other than the limited pixel is 0 (when all the eight adjacent pixels are limited pixels), the first distribution coefficient determining unit 423 sets a value (0, etc.) indicating that pixels other than the limited pixels are absent. The first distribution coefficient determining unit 423 outputs first distribution coefficient data representing the first distribution coefficient for each of the pixels. The first distribution coefficient data indicated by a sign “e” is obtained from the first limited pixel data indicated by the sign “d”.

The first addition amount determining unit 424 calculates an addition amount (a first addition amount) of each of the pixels on the basis of the first limited amount signal and the first distribution coefficient data. Specifically, the first addition amount determining unit 424 calculates the first addition amount by performing, for each of the pixels, weighted addition of saturation amounts of pixels around the pixel (eight adjacent pixels) with weight corresponding to the first distribution coefficient. In this embodiment, since adjustment of a pixel value for compensating a change in brightness is not performed for the limited pixels, the first addition amount is set to 0. The first addition amount determining unit 424 outputs, for each of the pixels, first addition amount data representing the first addition amount. The first addition amount data indicated by a sign “f” is obtained from the first limited amount signal indicated by the sign “c” and the first distributed coefficient data indicated by the sign “e”.

Like the addition amount limiting unit 118 explained in the first embodiment, the first addition amount limiting unit 425 limits the first addition amount such that a pixel value does not exceed DMAX when the first addition amount is added to a pixel value of the limited image data (limitation processing). The first addition amount limiting unit 425 outputs the first addition amount data after the limitation processing as first limited addition amount data. The first addition amount limiting unit 425 outputs a second limited amount signal representing a limited amount by the limitation processing for each of the pixels. The second limited amount signal indicated by a sign “g” is obtained from the limited image data indicated by the sign “b” and the first addition amount indicated by the sign “f”.

Like the addition unit 119 explained in the first embodiment, the first addition unit 426 generates compensated image data (first compensated image data) from the first limited addition amount data and the limited image data and outputs the compensated image data. In the example shown in FIGS. 13A and 13B, the first compensated image data indicated by a sign “h” is obtained.

Like the first limited pixel detecting unit 422, the second limited pixel detecting unit 427 detects a limited pixel on the basis of the second limited amount signal. The “limited pixel” is a total adjustment amount limited pixel, which is a pixel limited in a total adjustment amount. The second limited pixel detecting unit 427 generates and outputs second limited pixel data in which 1 is allocated to the total adjustment amount limited pixel and the limited pixel detected by the first limited pixel detecting unit 422 and 0 is allocated to the other pixels. That is, the second limited pixel detecting unit 427 outputs, as the second limited pixel data, OR of a detection result of the total adjustment amount limited pixel and a detection result of the first limited pixel detecting unit 422 such that an addition amount is not added to the limited pixel detected by the first limited pixel detecting unit 422. The second limited pixel data indicated by a sign “i” is obtained from the second limited amount signal indicated by the sign “g” and the first limited pixel data indicated by the sign “d”.

Like the first distribution coefficient determining unit 423, the second distribution coefficient determining unit 428 calculates a distribution coefficient (a second distribution coefficient) on the basis of the second limited pixel data. The second distribution coefficient determining unit 428 outputs second distribution coefficient data representing the second distribution coefficient for each of the pixels. The second distribution coefficient data indicated by a sign “j” is obtained from the second limited pixel data indicated by the sign “i”.

Like the first addition amount determining unit 424, the second addition amount determining unit 429 calculates an addition amount (a second addition amount) of each of the pixels on the basis of the second limited amount signal and the second distribution coefficient data. The second addition amount determining unit 429 outputs second addition amount data representing the second addition amount for each of the pixels. The second addition amount data indicated by a sign “k” is obtained from the second limited amount signal indicated by the sign “i” and the second distribution coefficient data indicated by the sign “j”.

Like the first addition amount limiting unit 425, the second addition amount limiting unit 430 limits a second addition amount such that a pixel value does not exceed DMAX when the second addition amount is added to a pixel value of the first compensated image data (limitation processing). The second addition amount limiting unit 430 outputs second addition amount data after the limitation processing as second limited addition amount data. The second addition amount limiting unit 430 does not output a signal (data) representing a limited amount by the limitation processing. Even if the second addition amount data indicated by a sign “k” is added to the first compensated image data indicated by the sign “h”, since the pixel value does not exceed DMAX, second limited addition amount data is the same as the second addition amount data indicated by the sign “k”.

Like the first addition unit 426, the second addition unit 431 generates compensated image data (second compensated image data; final compensated image data) from the second limited addition amount data and the first compensated image data and outputs the compensated image data. In the example shown in FIGS. 13A and 13B, the second compensated image data indicated by a sign “l” is obtained from the first compensated image data indicated by the sign “h” and the second addition amount data (the second limited addition amount data) indicated by a sign “k”.

Processing (compensation processing) by the first limited pixel detecting unit 422, the first distribution coefficient determining unit 423, the first addition amount determining unit 424, the first addition amount limiting unit 425, and the first addition unit 426 is repeated by the second limited pixel detecting unit 427, the second distribution coefficient determining unit 428, the second addition amount determining unit 429, the second addition amount limiting unit 430, and the second addition unit 431.

As explained above, according to this embodiment, a pixel value of pixels around a total adjustment amount limited pixel are adjusted such that a change in brightness due to limitation of a total adjustment amount for the total adjustment amount limited pixel is compensated. Consequently, a high effect can be obtained as the effect of suppressing deterioration in image quality. Specifically, when a change in brightness due to limitation of a pixel value cannot be sufficiently compensated, it is possible to sufficiently compensate the change in the brightness by adjusting the pixel values of the pixels around the total adjustment amount limited pixel.

In this embodiment, the compensation processing is repeated twice. However, if the number of times of repetition of the compensation processing is increased, it is possible to more surely compensate the change in the brightness due to the limitation of the pixel value.

The configuration of this embodiment (the configuration for adjusting pixel values of pixels around a total adjustment amount limited pixel) can be applied to the configurations of the second embodiment and the third embodiment as well.

### Fifth Embodiment

A display apparatus and a control method for the display apparatus according to a fifth embodiment of the present invention are explained below with reference to the drawings. In the example explained in the first to fourth embodiments, a pixel value is set to a value outside the predetermined range according to the image processing for correcting input image data according to the light emission brightness of the backlight. However, the pixel value is sometimes a value outside the predetermined range and is limited to a value within the predetermined range according to image processing other than the image processing explained above. Irrespective of a type of image processing, if the pixel value is limited to a value within the predetermined range, a change in brightness due to the limitation of the pixel value occurs and image quality is deteriorated. Therefore, in this embodiment, an example of a display apparatus that performs image processing different from the image processing explained above is explained.

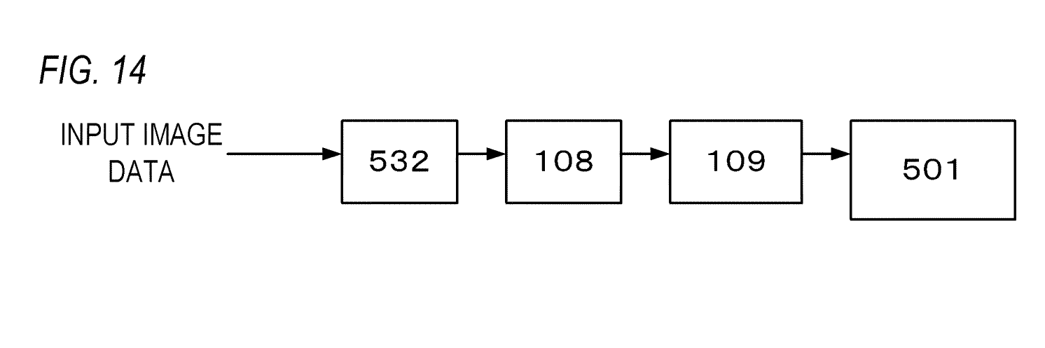

FIG. 14 is a diagram showing an example of a functional configuration of the display apparatus according to this embodiment.

The display apparatus according to this embodiment includes a display unit 501, an image processing unit 532, the limiting unit 108, and the compensating unit 109.

The operations of the limiting unit 108 and the compensating unit 109 are the same as the operations in the first embodiment.

The display unit 501 is a display panel configured to display an image based on image data. The display unit 501 is, for example, an organic EL display panel or a plasma display panel.

The image processing unit 532 generates processed image data, for example, by applying the predetermined image processing, with which a pixel value after processing is likely to be a value outside the predetermined range, to input image data. The image processing unit 532 outputs the generated processed image data. The predetermined image processing is edge enhancement processing, blurring processing, color adjustment processing, brightness adjustment processing, gradation conversion processing, or the like. When a pixel value after the processing is a value outside the predetermined range, as explained in the first embodiment, brightness and a color have values different from desired values.

In this embodiment, as in the first embodiment, the pixel value set to the value outside the predetermined range according to the image processing of the image processing unit 532 is limited to a value within the predetermined range by the limiting unit 108. As in the first embodiment, pixel values of pixels around a limited pixel are adjusted such that a change in brightness due to limitation of a pixel value of the limited pixel is compensated. Consequently, as in the first embodiment, it is possible to suppress deterioration in image quality caused by limiting a pixel value outside the predetermined range to a value within the predetermined range.

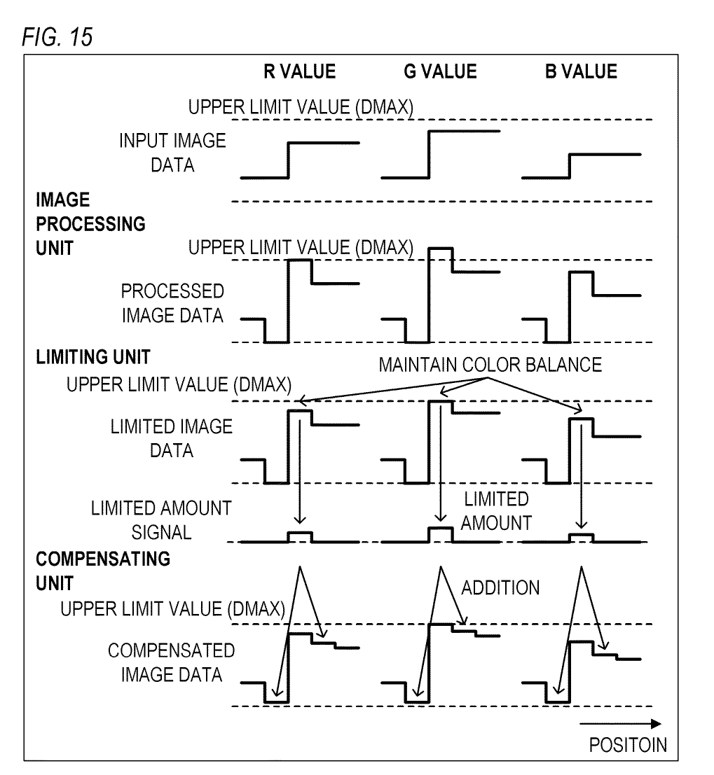

An example of processing of the display apparatus according to this embodiment (an example of various signal values) is shown in FIG. 15.

In the example shown in FIG. 15, the G value exceeds DMAX according to image processing. Therefore, the R value, the G value, and the B value are adjusted (limited) to set the G value to DMAX while keeping a color balance, whereby limited image data is generated. A change (a limited amount) of a pixel value by the adjustment is added to pixel values of pixels around the pixel while the color balance is kept, whereby compensated image data is generated.

As explained above, according to this embodiment, even when a pixel value is a value outside the predetermined range, according to image processing other than image processing for correcting input image data according to the light emission brightness of the backlight, it is possible to suppress deterioration in image quality caused by limitation of the pixel value.

The configuration of this embodiment (the configuration for performing image processing other than image processing for correcting input image data according to the light emission brightness of the backlight) can be applied to the configurations of the second to fourth embodiments as well.

The display apparatus according to this embodiment is not limited to the display apparatus according to the first to fourth embodiments (the backlight unit and the display apparatus that transmits light from the backlight unit and displays an image). The display apparatus according to this embodiment may be a display apparatus not including an independent light source.

### Sixth Embodiment

A display apparatus and a control method for the display apparatus according to a sixth embodiment of the present invention are explained below with reference to the drawings.

In the example explained in the first to fifth embodiments, processed image data is generated by applying the predetermined image processing to input image data and a pixel value of the processed image data is adjusted. In an example explained in this embodiment, processed image data is not generated.

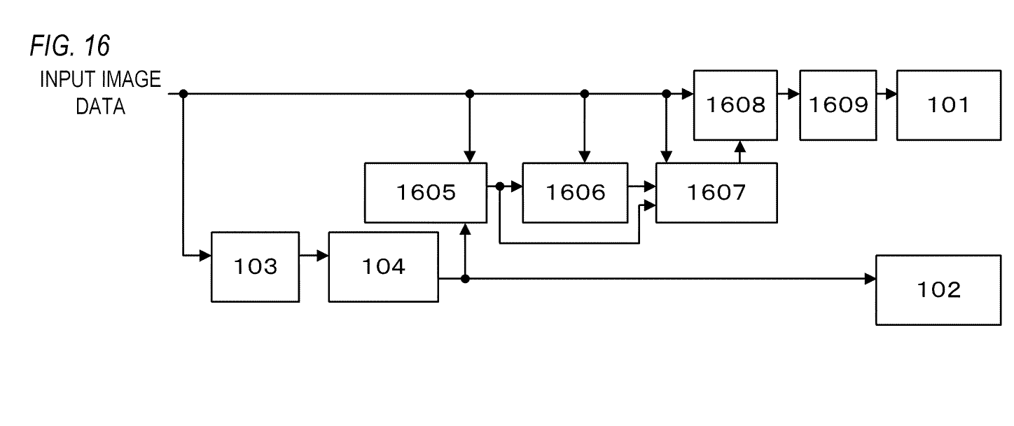

FIG. 16 is a block diagram showing an example of a functional configuration of the display apparatus according to this embodiment. The display apparatus according to this embodiment includes the liquid crystal panel unit 101, the backlight unit 102, the characteristic value detecting unit 103, the light emission brightness determining unit 104, a correction data generating unit 1605, a limited pixel detecting unit 1606, a correction data adjusting unit 1607, a correcting unit 1608, and a Limit unit 1609.

The operations of the liquid crystal panel unit 101, the backlight unit 102, and the characteristic value detecting unit 103 are the same as the operations in the first embodiment.

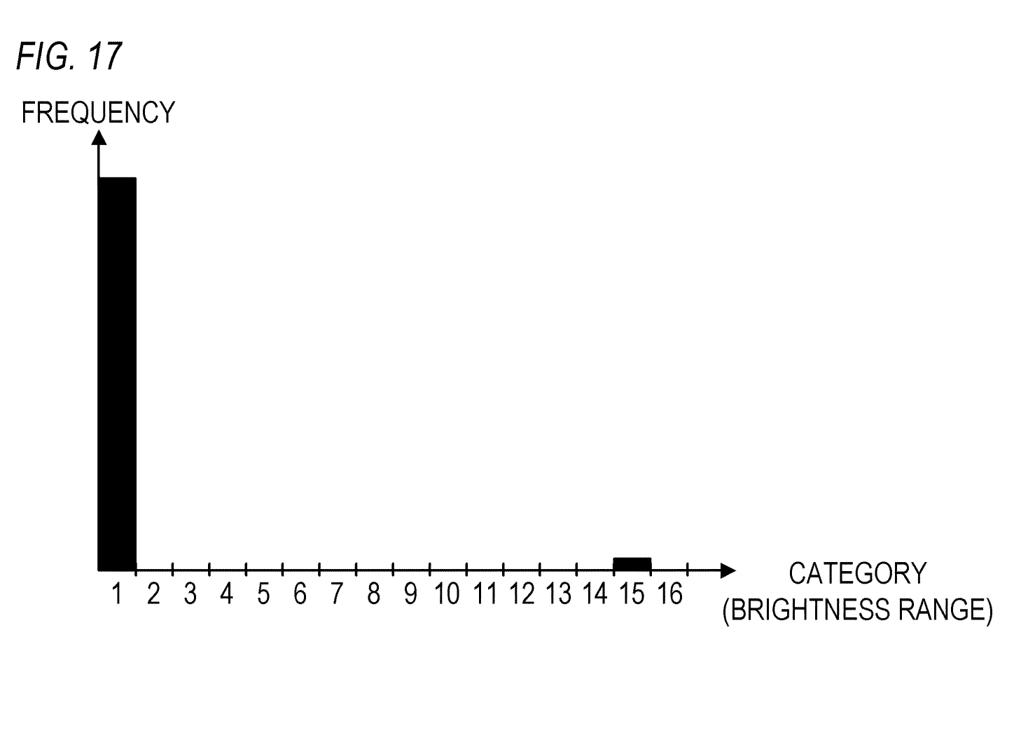

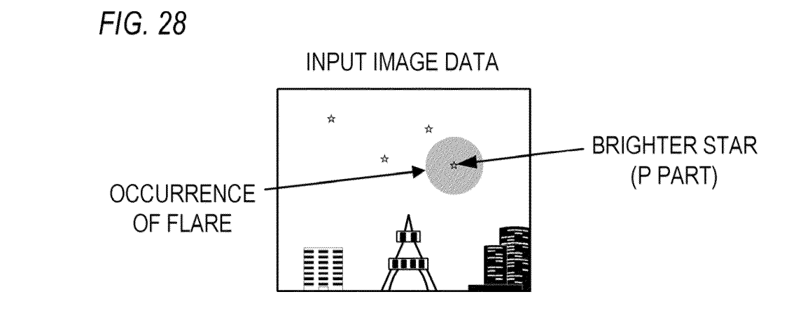

An example of input image data is shown in FIG. 28. Concerning an image region including a brighter star (a P part) in the input image data shown in FIG. 28, a histogram shown in FIG. 17 is obtained as a characteristic value. FIG. 17 is an example of a histogram of sixteen categories obtained by equally dividing a range of possible brightness (in this embodiment, 0 to 255) into sixteen. In the histogram shown in FIG. 17, a frequency is concentrated on a category 1, which is a brightness range of 0 to 15. In the example of FIG. 17, a few pixels are present in a category 15, which is a brightness range of 224 to 239. In FIG. 17, the pixels in the category 15 are pixels in the P part.

The light emission brightness determining unit 104 has a function same as the function in the first embodiment. However, in this embodiment, light emission brightness is determined by a method different from the method in the first embodiment.

Specifically, the light emission brightness determining unit 104 determines, for each of the backlight regions, a largest category from a histogram of an image region corresponding to the backlight region. The largest category is a category on a highest brightness side among categories in which the frequency is equal to or higher than 1. The light emission brightness determining unit 104 determines light emission brightness of each of the backlight regions such that the light emission brightness is higher as a number of the largest category is larger (the light emission brightness is higher as maximum brightness of an image displayed in the backlight region is higher). In this embodiment, numbers 1 to 16 are given to the sixteen categories in order from a low brightness side.

However, an image displayed in the backlight region in which the histogram shown in FIG. 17 is obtained includes only a few light regions and includes many dark regions. When the light emission brightness of the backlight region is controlled to a high value corresponding to the number of the largest category, floating black called flare occurs as shown in FIG. 28. Therefore, in this embodiment, light emission brightness is determined such that light emission brightness is lower when an image displayed in the backlight region includes only a few light regions and include many dark regions than when the image includes many light regions.

Specifically, in this embodiment, the light emission brightness determining unit 104 determines, according to the number of the largest category, a lower first reduction ratio β (β≦1) as the number of the largest category is larger. The light emission brightness determining unit 104 determines, on the basis of the histogram, a lower second reduction ratio γ (γ≦1) as the likelihood of occurrence of a flare is higher when the light emission brightness is controlled to a value corresponding to the number of the largest category. The light emission brightness determining unit 104 determines light emission brightness BLC (=γβBd) by reducing standard light emission brightness Bd at the first reduction ratio β and the second reduction ratio γ.

A determination method for γ is not specifically limited. For example, according to the frequency of the largest category, higher γ may be determined as the frequency of the largest category is higher. According to a difference between the number of the largest category and a number of a category in which the frequency is the highest, lower γ may be determined as the difference is larger.

The correction data generating unit 1605 generates, on the basis of input image data and the predetermined image processing, correction data representing a correction value for each of the pixels for correcting a pixel value of the input image data to a pixel value applied with the predetermined image processing. In this embodiment, as in the first embodiment, the predetermined image processing is processing for correcting the input image data according to the light emission brightness of the backlight unit 102. Therefore, the correction data generating unit 1605 determines, for each of the pixels, a correction value for the pixel using the pixel value of the input image data and the light emission brightness determined by the light emission brightness determining unit 104. Consequently, correction data is generated.

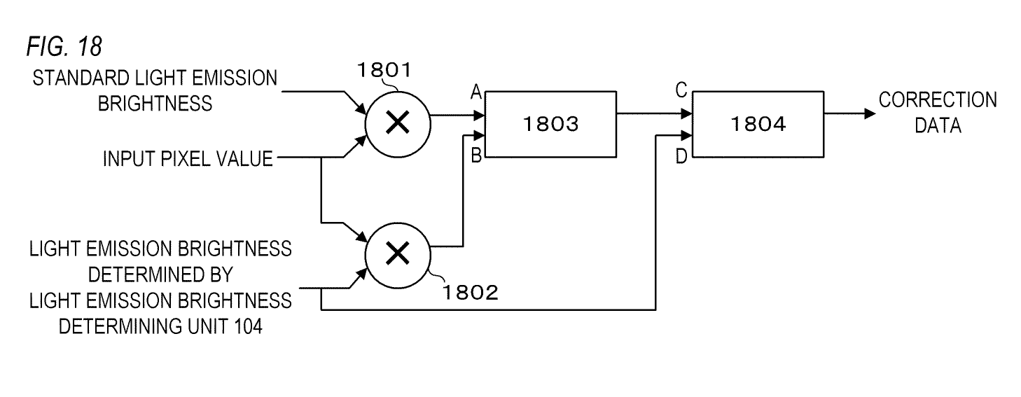

An example of a functional configuration of the correction data generating unit 1605 is shown in FIG. 18.

The correction data generating unit 1605 includes multipliers 1801 and 1802, a difference calculating unit 1803, and a division unit 1804.

The standard light emission brightness Bd and an input pixel value of a pixel (a pixel value of input image data) to be subjected to correction value determination processing (processing for determining a correction value) are input to the multiplier 1801. The multiplier 1801 multiplies the standard light emission brightness with the input pixel value. When an input pixel value of a pixel in the P part shown in FIG. 28 is 224, a multiplication result concerning the pixel is 224 Bd.

The light emission brightness of each of the backlight regions determined by the light emission brightness determining unit 104 and the input pixel value of the pixel to be subjected to the correction value determination processing are input to the multiplier 1802. The multiplier 1802 multiplies the light emission brightness BLC (=γβBd) of the backlight region, in which the pixel to be subjected to the correction value determination processing is displayed, with the input pixel value. A multiplication result concerning the pixel in the P part shown in FIG. 28 is 224 BLC (=224 γβBd).

The multiplication result of the multiplier 1801 is input to an input port A of the difference calculating unit 1803. The multiplication result of the multiplier 1802 is input to an input port B of the difference calculating unit 1803. The difference calculating unit 1803 subtracts the value input to the input port B from the value input to the input port A. A subtraction result of the difference calculating unit 1803 indicates a shortage of brightness that occurs when light emission brightness is controlled from the standard light emission brightness Bd to the light emission brightness BLC. When the pixel in the P part shown in FIG. 28 is subjected to the correction value determination processing, 224 Bd is input to the input port A and 224 γβBd is input to the input port B. 224Bd−224γβBd=224(1−γβ)Bd is calculated.

The subtraction result of the difference calculating unit 1803 is input to an input port C of the division unit 1804. The light emission brightness of each of the backlight regions determined by the light emission brightness determining unit 104 is input to an input port D of the division unit 1804. The division unit 1804 divides the value input to the input port C by the value input to the input port D (the light emission brightness of the backlight region in which pixel to be subjected to the correction value determination processing is displayed). It is possible to calculate a correction value necessary for compensating the shortage of the brightness by dividing the shortage of the brightness by the light emission brightness BLC. When the pixel in the P part shown in FIG. 28 is subjected to the correction value determination processing, 224(1−γβ)Bd is input to the input port C and the light emission brightness BLC (=γβBd) is input to the input port D as the light emission brightness of the backlight region in which the pixel to be subjected to the correction value determination processing is displayed. (224(1−γβ)Bd)/(γβBd)=224·(1−γβ)/γβ is calculated as a division result. The division unit 1804 outputs the division result for each of the pixels to the limited pixel detecting unit 1606 as correction data.

The limited pixel detecting unit 1606 detects, on the basis of the input image data and the correction data (the calculation result of the correction data generating unit 1605), a pixel, a pixel value of which is set to a value outside the predetermined range by applying the predetermined image processing to the input image data, as a limited pixel. Specifically, the limited pixel detecting unit 1606 performs limited pixel determination processing for each of the pixels. The limited pixel determination processing is processing for adding a correction value to an input pixel value, calculating a saturation amount from an addition result, and determining, on the basis of the saturation amount, whether the pixel if a limited pixel.

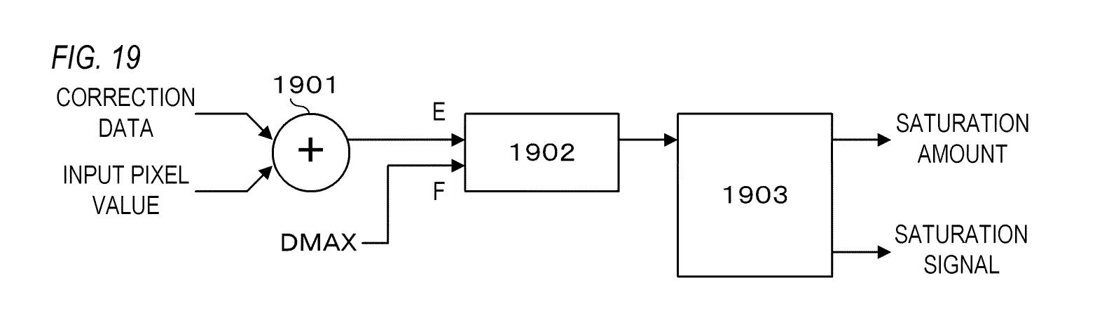

An example of a functional configuration of the limited pixel detecting unit 1606 is shown in FIG. 19.

The limited pixel detecting unit 1606 includes an addition unit 1901, a difference calculating unit 1902, and a saturation determining unit 1903.

The correction data and the input pixel value of the pixel to be subjected to the limited pixel determination processing are input to the addition unit 1901. The addition unit 1901 adds the correction value for the pixel to be subjected to the limited pixel determination processing to the input pixel value of the pixel to be subjected to the limited pixel determination processing. The addition unit 1901 outputs an addition result to the difference calculating unit 1902. When the pixel in the P part of FIG. 28 is subjected to the limited pixel determination processing, 224 is input as the input pixel value. 224(1−γβ)/γβ is input as the correction value for the pixel. 224+224(1−γβ)/γβ=224/γβ is calculated as an addition result.

The addition result of the addition unit 1901 is input to an input port E of the difference calculating unit 1902. DMAX (a maximum value of a pixel value that can be input to the liquid crystal panel unit 101: in this embodiment, 255) is input to an input port F of the difference calculating unit 1902. DMAX is recorded in advance, for example, in a not-shown storing unit. The difference calculating unit 1902 subtracts the value input to the input port F from the value input to the input port E. A subtraction result is a saturation amount. The difference calculating unit 1902 outputs the subtraction result to the saturation determining unit 1903. When the pixel in the P part shown in FIG. 28 is subjected to the limited pixel determination processing, 224/γβ is input to the input port E, 255 is input to the input port F, and 224/γβ−255 is calculated as the subtraction result. When the subtraction result is negative, the difference calculating unit 1902 corrects the subtraction result to 0.

The saturation determining unit 1903 determines, on the basis of the subtraction result of the difference calculating unit 1902, whether the pixel is a limited pixel. The saturation determining unit 1903 outputs a determination result concerning whether the pixel is a limited pixel (a saturation signal) and the saturation amount to the correction data adjusting unit 1607. Specifically, concerning a pixel, the saturation amount of which is positive, it is determined that the pixel is a limited pixel, 1 is output as the saturation signal, and the subtraction result of the difference calculating unit 1902 is directly output as the saturation amount. Concerning a pixel, the saturation amount of which is 0 or negative, it is determined that the pixel is not a limited pixel, 0 is output as the saturation signal, and 0 is output as the saturation amount. When the subtraction result (224/γβ−255) for the pixel in the P part shown in FIG. 28 is positive, 1 is output as the saturation signal of the pixel and 224/γβ−255 is output as the saturation amount of the pixel.

The correction data adjusting unit 1607 and the correcting unit 1608 generate corrected image data on the basis of the input image data, the correction data, and the detection result of the limited pixel detecting unit 1606 (corrected image generation). The corrected image data is image data in which a pixel value outside the predetermined range is limited to a value within the predetermined range among pixel values of image data generated by applying the predetermined image processing to the input image data. The corrected image data is image data in which pixel values of pixels around a pixel limited in a pixel value is adjusted such that a change in brightness due to the limitation of the pixel value outside the predetermined range is compensated.

The correction data adjusting unit 1607 adjusts a correction amount for a limited pixel such that a pixel value after the predetermined image processing of the limited pixel is limited to a value within the predetermined range. The correction data adjusting unit 1607 adjusts a correction value for pixels around the limited pixel such that a change in brightness due to the limitation of the pixel value of the limited pixel is compensated. According to the processing, adjustment and correction data is generated. In an example explained in this embodiment, for simplification of explanation, the pixels around the limited pixel are two pixels adjacent to the left and right sides of the limited pixel. However, the pixels around the limited pixel are not limited to the two pixels. For example, the pixels around the limited pixel may be two pixels adjacent to the upper and lower sides of the limited pixel, may be four pixels adjacent to the upper, lower, left, and right sides of the limited pixel, or may be eight pixels adjacent to the limited pixel (eight pixels adjacent to the upper, lower, right, left, upper right, lower right, upper left, and lower left sides of the limited pixel).

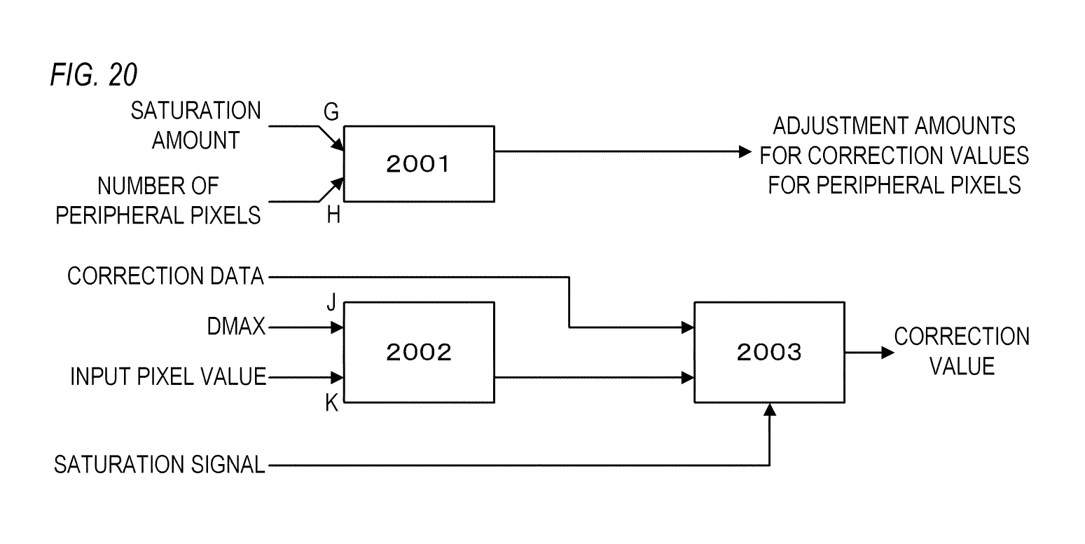

An example of a functional configuration of the correction data adjusting unit 1607 is shown in FIG. 20. The correction data adjusting unit 1607 performs processing for each of the pixels.

The correction data adjusting unit 1607 includes a division unit 2001, a difference calculating unit 2002, and a MUX unit 2003.

A saturation amount is input to an input port G of the division unit 2001 from the limited pixel detecting unit 1606. The number of pixels around a limited pixel (peripheral pixels) is input to an input port H of the division unit 2001. The division unit 2001 divides the saturation amount input to the input port G by the value input to the input port H. Consequently, an adjustment amount for a correction value for the pixels around the limited pixel is calculated as a division result. Specifically, when a pixel to be processed is a limited pixel, an adjustment amount for a correction value for compensating a change in brightness due to limitation of a pixel value of the limited pixel is calculated as the division result. When the pixel to be processed is not a limited pixel, 0 (a value for not adjusting the correction value) is calculated as the division result. The division unit 2001 outputs the division result (the adjustment amount) to the correcting unit 1608 as an adjustment amount for the correction amount BLC of the peripheral pixels. As explained above, in this embodiment, the number of peripheral pixels is two. When the pixel in the P part shown in FIG. 28 is a processed, 224/γβ−255 is input to the input port G, 2 is input to the input port H, and (224/γβ−255)/2 is calculated as the division result.

DMAX (255) is input to an input port J of the difference calculating unit 2002. An input pixel value of the pixel to be processed is input to an input port K of the difference calculating unit 2002. The difference calculating unit 2002 subtracts the value input to the input port K from the value input to the input port J. Consequently, a correction value for correcting the input pixel value to DMAX is calculated as a subtraction result. That is, when the pixel to be processed is the limited value, a correction value for correcting an input pixel value of the limited pixel to a pixel value after limitation is calculated as the subtraction result. The difference calculating unit 2002 outputs the subtraction result to the MUX unit 2003. When the pixel in the P part shown in FIG. 28 is processed, 255 is input to the input port J, 224 is input to the input port K, and 31 is calculated as the subtraction result.

The correction data generated by the correction data generating unit 1605, the subtraction result of the difference calculating unit 2002, and the determination result (the saturation signal) of the limited pixel detecting unit 1606 are input to the MUX unit 2003. The MUX unit 2003 outputs the correction value of the correction data or the subtraction result of the difference calculating unit 2002 to the correction unit 1608 as a correction value. Specifically, when the saturation signal is 0, i.e., when the pixel to be processed is not a limited pixel, the MUX unit 2003 outputs the correction value of the correction data as the correction value. When the saturation signal is 1, i.e., the pixel to be processed is a limited pixel, the MUX unit 2003 outputs the subtraction result of the difference calculating unit 2002 as the correction value. Since the saturation signal for the pixel in the P part shown in FIG. 28 is 1, when the pixel is processed, 31, which is the subtraction result of the difference calculating unit 2002, is output as a correction value for the pixel.

In the example explained in this embodiment, the correction value and the adjustment amount for each of the pixels are output as the adjustment and correction data. However, a sum of the correction value and the adjustment amount may be calculated as an adjustment and correction value for each of the pixels and the adjustment and correction value for each of the pixels may be output as adjustment and correction data.

The correcting unit 1608 generates corrected image data by correcting pixel values of the input image data using the adjustment and correction data (a first correcting unit). In this embodiment, the correcting unit 1608 adds, for each of the pixels, the correction value and the adjustment amount input from the correction data adjusting unit 1607 to the input pixel value. Consequently, corrected image data is generated. The correcting unit 1608 outputs the corrected image data to the Limit unit 1609. When the input pixel value of the pixels around the pixel in the P part shown in FIG. 28 is 10, an adjustment amount for the peripheral pixels is (224/γ−255)/2. Therefore, pixel values after correction of the peripheral pixels are 10+(224/γβ−255)/2=(224/γβ−235)/2.

As explained above, in this embodiment, the adjustment amount is calculated by dividing the saturation amount by the number of peripheral pixels. Therefore, in this embodiment, corrected image data in which pixel values of a plurality of peripheral pixels are adjusted by the same adjustment amount is generated.

The Limit unit 1609 outputs the corrected image data to the liquid crystal panel unit 101 with a pixel value outside the predetermined range limited to a value within the predetermined range. In this embodiment, not only the correction value but also the adjustment amount is added to the input pixel value of the peripheral pixels. Therefore, the pixel values after correction of the peripheral pixels sometimes exceed DMAX (255). The Limit unit 1609 applies processing for limiting the pixel values after correction to DMAX to the peripheral pixels, the pixel values after correction of which exceeds DMAX.

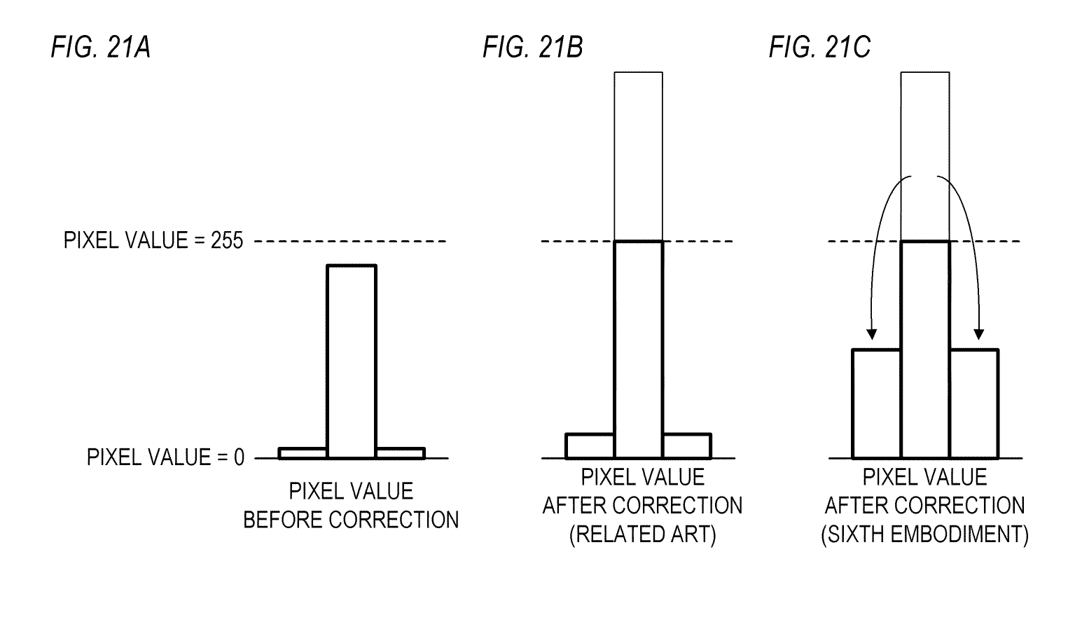

Examples of pixel values of a limited pixel and peripheral pixels are shown in FIGS. 21A to 21C. FIG. 21A shows pixel values before correction. FIG. 21B shows pixel values after correction in the related art. FIG. 21C shows pixel values after correction in this embodiment. Broken lines in FIGS. 21A to 21C indicate DMAX (in this embodiment, 255), thick lines indicate pixel values, and thin lines indicate limited amounts (limited amounts of the pixel values).

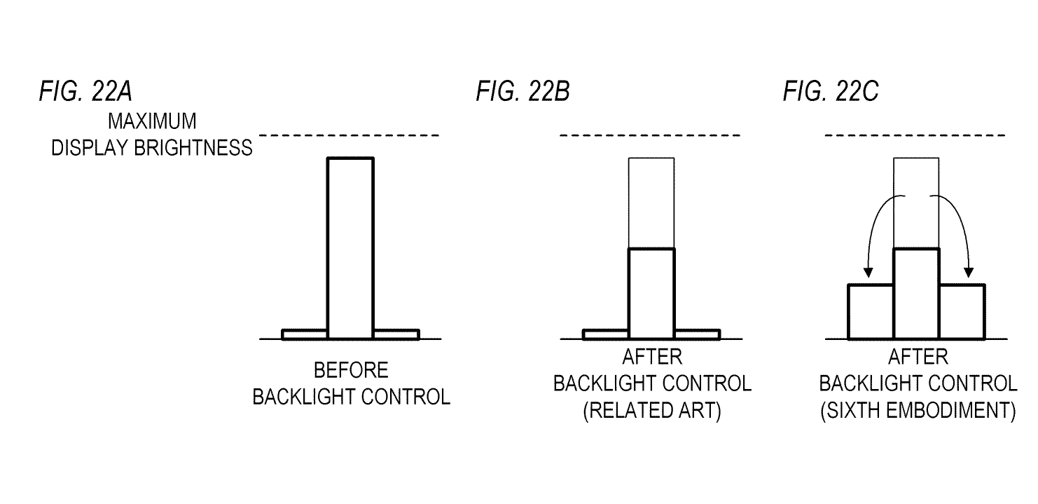

Examples of display brightnesses of the limited pixel and the peripheral pixels are shown in FIGS. 22A to 22C. FIG. 22A shows display brightnesses obtained when the light emission brightness of each of the backlight regions is not controlled (before backlight control). That is, FIG. 22A shows display brightnesses obtained when the backlight unit is caused to emit light at the standard light emission brightness to display the pixel values before correction. FIG. 22B shows display brightnesses in the related art obtained when the light emission brightness of each of the backlight regions is controlled (after the backlight control). That is, FIG. 22B shows display brightnesses obtained when the backlight unit is caused to emit light at the light emission brightness BLC determined by the light emission brightness determining unit 104 to display the pixel values after correction in the related art. FIG. 22C shows display brightnesses in this embodiment obtained when the light emission brightness of each of the backlight regions is controlled (after the backlight control). That is, FIG. 22C shows display brightnesses obtained when the backlight unit is caused to emit light at the light emission brightness BLC determined by the light emission brightness determining unit 104 to display the pixel values after correction in this embodiment. Broken lines in FIGS. 22A to 22C indicate a maximum value of values that display brightness can take (display brightness obtained when the backlight unit is caused to emit light at the standard light emission brightness to display the pixel value DMAX). Thick lines in FIGS. 22A to 22C indicate display brightnesses and thin lines indicate shortages of the display brightnesses.

As shown in FIGS. 21A to 21C and 22A to 22C, in the related art, the pixel values of the limited pixel is only limited. Therefore, a change (a fall) in display brightness due to the limitation of the pixel value of the limited pixel occurs. On the other hand, in this embodiment, the pixel values of the peripheral pixels are adjusted such that a change in brightness due to the limitation of the pixel value of the limited pixel is compensated. Consequently, it is possible to suppress deterioration in image quality (a change in display brightness) caused by limiting a pixel value outside the predetermined range to a value within the predetermined range.

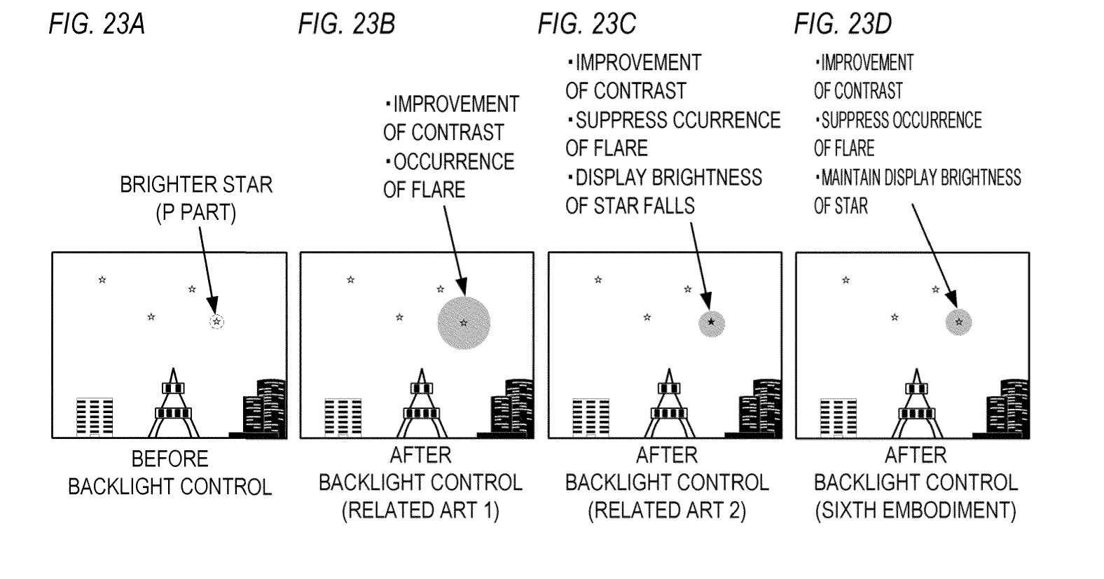

An example of display images are shown in FIGS. 23A to 23D.

FIG. 23A shows a display image displayed when the light emission brightness of each of the backlight regions is not controlled (before backlight control).

FIG. 23B shows a display image in the related art displayed when the light emission brightness of each of the backlight regions is controlled such that maximum brightness of display brightness is secured (after the backlight control). In the example shown in FIG. 23B, it is possible to increase the contrast of the display image by controlling the light emission brightness of each of the backlight regions. However, since the light emission brightness of the backlight region including only a few light regions and including many dark regions is controlled to a high value, a flare occurs. Specifically, a flare occurs in the backlight region including the brighter star (the P part).

FIG. 23C shows a display image in the related art displayed when the light emission brightness of each of the backlight regions is controlled such that the light emission brightness of the backlight region including only a few light regions and including may dark regions is controlled to a high value (after the backlight control). In the example shown in FIG. 23C, it is possible to increase the contrast of the display image by controlling the light emission brightness of each of the backlight regions. Since the light emission brightness of the backlight region including only a few light regions and including many dark regions is controlled to a low value, it is possible to suppress occurrence of a flare. However, in a pixel having a high input pixel value among the pixels in the backlight region, the light emission brightness of which is controlled to a low value, a change in display brightness due to a change in the light emission brightness of the backlight region is not sufficiently compensated even if a pixel value of the pixel is corrected. Therefore, the pixel is displayed dark. In other words, a pixel value of a pixel, a pixel value of which after correction exceeds DMAX, is limited to DMAX. Therefore, the pixel is displayed dark. Specifically, the P part is displayed dark.

FIG. 23D shows a display image in this embodiment displayed when the light emission brightness of each of the backlight regions is controlled such that the light emission brightness of the backlight region including only a few light regions and including many dark regions is controlled to a high value (after the backlight control). In this embodiment, it is possible to increase the contrast of the display image by controlling the light emission brightness of each of the backlight regions. Since the light emission brightness of the backlight region including only a few light regions and including many dark regions is controlled to a low value, it is possible to suppress occurrence of a flare. Further, since pixel values of peripheral pixels are adjusted such that a change in brightness due to limitation of a pixel value of a limited pixel is compensated, it is possible to suppress a change in display brightness due to the limitation of the pixel value of the limited pixel. Specifically, it is possible to lightly display the P part.

As explained above, according to this embodiment, it is possible to suppress deterioration in image quality caused by limiting a pixel value outside the predetermined range to a value within the predetermined range.

A calculation method for correction data is not limited to the method explained above. For example, a correction value may be calculated by calculating a ratio α (α=Lb/Lca≧1) of the standard light emission brightness Bd and the light emission brightness BLC determined by the light emission brightness determining unit and multiplying (α−1) with an input pixel value.

In this embodiment, the image data input to the Limit unit is referred to as corrected image data. However, image data output from the Limit unit may be referred to as corrected image data.

### Seventh Embodiment

A display apparatus and a control method for the display apparatus according to a seventh embodiment of the present invention are explained below with reference to the drawings. In the sixth embodiment, a change in brightness due to limitation of a pixel value of a limited pixel is compensated by peripheral pixels. However, a change in brightness due to limitation of a pixel value of a limited pixel sometimes cannot be sufficiently compensated by only peripheral pixels. In this embodiment, when a change in brightness due to limitation of a pixel value of a limited pixel cannot be sufficiently compensated by pixels around the limited pixel, pixel values after correction (pixel values of corrected image data) of pixels on the outer side of the pixels around the limited pixel are corrected. Consequently, the change in brightness that cannot be sufficiently compensated by the pixels around the limited pixel can be compensated.

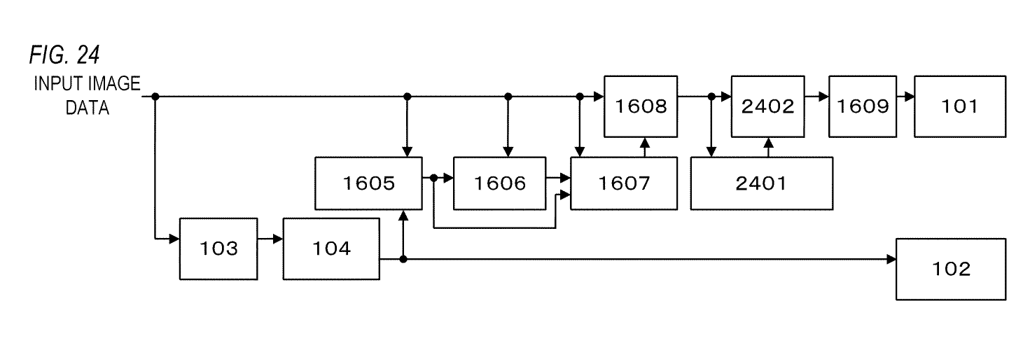

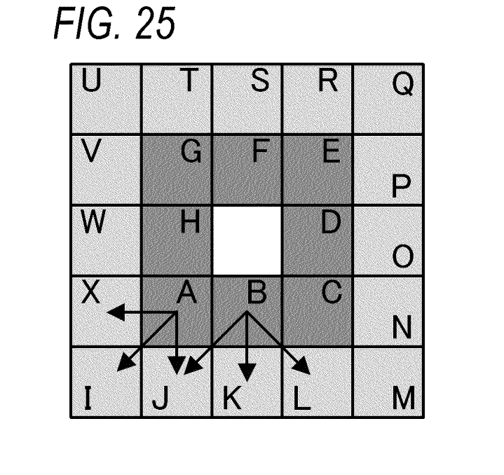

FIG. 24 is a block diagram showing an example of a functional configuration of the display apparatus according to this embodiment. The display apparatus according to this embodiment includes a second correction data generating unit 2401 and a second correcting unit 2402 besides the functional units in the sixth embodiment (FIG. 16). Functional units same as the functional units in the sixth embodiment are denoted by the same reference numerals and explanation of the functional units is omitted.

When a change in brightness due to limitation of a pixel value of a limited pixel cannot be sufficiently compensated by peripheral pixels, the second correction data generating unit 2401 and the second correcting unit 2402 correct pixel values after correction of pixels on the outer side of the peripheral pixels.

Corrected image data is input to the second correction data generating unit 2401 from the correcting unit 1608. The second correction data generating unit 2401 determines whether pixel values after correction of peripheral pixels are values within the predetermined range. When the pixel values after correction of the peripheral pixels are values outside the predetermined range, this means that a change in brightness due to limitation of a pixel value of a limited pixel cannot be sufficiently compensated by the peripheral pixels. When the pixel values after correction of the peripheral pixels are values outside the predetermined range, the second correction data generating unit 2401 determines, as a second correction value, a correction value for pixels on the outer side of the peripheral pixels viewed from the limited pixel (outer side pixels). Specifically, the second correction data generating unit 2401 determines, as the second correction value, a correction value for compensating a change in brightness that cannot be sufficiently compensated by the peripheral pixels. In this embodiment, the second correction data generating unit 2401 determines whether pixel values after correction of the peripheral pixels exceeds DMAX. When the pixel values after correction of the peripheral pixels exceeds DMAX, the second correction data generating unit 2401 calculates the second correction value for the outer side pixels by calculating a saturation amount of the pixel values after correction and dividing the saturation amount by the number (a predetermined number) of the outer side pixels.

The second correcting unit 2402 adds the second correction value determined by the second correction data generating unit 2401 to pixel values after correction of the outer side pixels. The second correcting unit 2402 outputs image data after correction (image data after processing for adding the second correction value to the pixel values after correction of the outer side pixels) to the Limit unit 1609.

FIG. 25 shows an example of processing of the display apparatus according to this embodiment. In FIG. 25, twenty-five pixels in total including five pixels in the horizontal direction×five pixels in the vertical direction are shown. A pixel in the center is a limited pixel. Pixels A to H are pixels around the limited pixel (peripheral pixels). Pixels I to X are pixels on the outer side of the peripheral pixels viewed from the limited pixel (pixels adjacent to the peripheral pixels; outer side pixels).

In this embodiment, as first processing, processing for compensating a change in brightness due to limitation of a pixel value of the limited pixel with the peripheral pixels is performed. As second processing, when the change in brightness due to limitation of a pixel value of the limited pixel cannot be sufficiently compensated by the peripheral pixels (when pixel values after correction of the peripheral pixels exceed DMAX), processing for compensating the change with the outer side pixels is performed.

In this embodiment, when a change in brightness due to limitation of a pixel value of the limited pixel cannot be sufficiently compensated by the peripheral pixels, pixel values after correction of three outer side pixels are corrected.

Specifically, when a pixel value after correction of the pixel A exceeds DMAX, the second correction value is calculated by dividing a saturation amount of the pixel value after correction of the pixel A by 3. The calculated second correction value is added to pixel values after correction of the pixels X, I, and J.

Similarly, when a pixel value after correction of the pixel B exceeds DMAX, the second correction value is calculated by dividing a saturation amount of the pixel value after correction of the pixel B by 3. The calculated second correction value is added to pixel values after correction of the pixels J, K, and L.

As explained above, according to this embodiment, when a change in brightness due to limitation of a pixel value of the limited pixel cannot be sufficiently compensated by the peripheral pixels, pixel values after correction of the outer side pixels are corrected such that the change in the brightness that cannot be sufficiently compensated by the peripheral pixels is compensated. Consequently, it is possible to suppress, more highly accurately than in the sixth embodiment, deterioration in image quality caused by limiting a pixel value outside the predetermined range to a value within the predetermined range.

In the example explained in this embodiment, pixel values after correction of three outer side pixels are corrected with respect to one peripheral pixel. However, correction of pixel values after correction is not limited to this. For example, pixel values after correction of sixteen pixels I to X shown in FIG. 25 may be corrected with respect to one peripheral pixel. Pixel values after correction of all outer side pixels adjacent to one peripheral pixel may be corrected with respect to the peripheral pixel. Specifically, pixel values after correction of the pixels I, J, W, and X may be corrected with respect to the pixel A.

In the example explained in this embodiment, pixels apart from the limited pixel by one pixel are peripheral pixels and pixels apart from the limited pixel by two pixels are outer side pixels. However, the peripheral pixels and the outer side pixels are not limited to this. For example, pixels included in a region apart from the limited pixel by two pixels may be the peripheral pixels and pixels other than the peripheral pixels among pixels included in a region apart from the limited pixel by four pixels may be the outer side pixels.

### Eighth Embodiment

A display apparatus and a control method for the display apparatus according to an eighth embodiment of the present invention are explained below with reference to the drawings. In the example explained in the sixth embodiment, corrected image data in which pixel values of peripheral pixels are adjusted by the same adjustment amount is generated. In an example explained in this embodiment, corrected image data in which pixel values of peripheral pixels are adjusted by an adjustment amount for equalizing pixel values (pixel values after correction) of the peripheral pixels one another is generated.

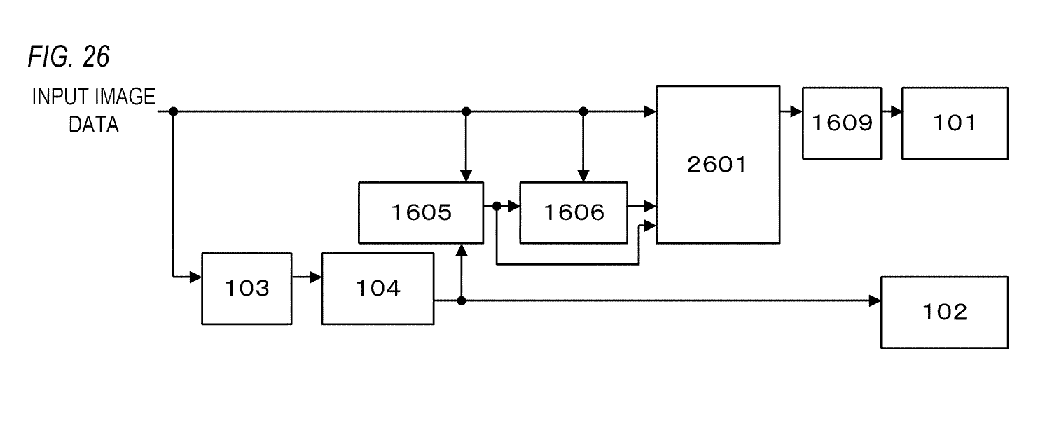

FIG. 26 is a block diagram showing an example of a functional configuration of the display apparatus according to this embodiment. The display apparatus according to this embodiment includes an image data correcting unit 2601 instead of the correction data adjusting unit 1607 and the correcting unit 1608 in the sixth embodiment (FIG. 16). Functional units same as the functional units in the sixth embodiment are denoted by the same reference numerals and explanation of the functional units is omitted.

The image data correcting unit 2601 generates corrected image data in which pixel values of peripheral pixels are adjusted by an adjustment amount for equalizing pixel values (pixel values after correction) of the peripheral pixels one another and outputs the corrected image data to the Limit unit 1609.

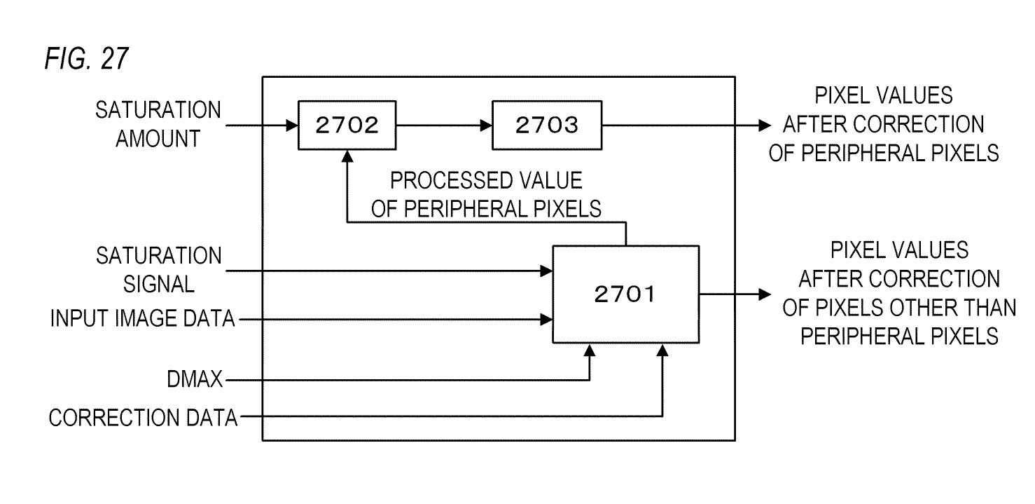

An example of a functional configuration the image data correcting unit 2601 is shown in FIG. 27.

The image data correcting unit 2601 includes an image processing unit 2701, an addition unit 2702, and a division unit 2703. An input image data, a correction data, a determination result (a saturation signal) of the limited pixel detecting unit 1606, a saturation amount, and DMAX are input to the image data correcting unit 2601.

The image processing unit 2701 adds, for each of the pixels, a correction value BLC to an input pixel value. The image processing unit 2701 determines, for each of the pixels, using a saturation signal, whether the pixel is a limited pixel, a peripheral pixel, or a pixel other than the limited pixel and the peripheral pixel. Concerning the limited pixel, the image processing unit 2701 limits a value obtained by adding the correction value BLC to the input pixel value to DMAX and outputs the limited value as a pixel value after correction. Concerning the pixel other than the limited pixel and the peripheral pixel, the image processing unit 2701 outputs, as the pixel value after correction, a value obtained by adding the correction value BLC to the input pixel value. Concerning the peripheral pixel, the image processing unit 2701 outputs a value obtained by adding the correction value BLC to the input pixel value to the addition unit 2702 as a processed value.

The addition unit 2702 calculates, for each of limited pixels, a sum of processed values (values obtained by adding the correction value BLC to input pixel values) of peripheral pixels of the limited pixel and a saturation amount of the limited pixel.

The division unit 2703 divides, for each of the limited pixels, a calculation result of the addition unit 2702 for the limited pixel by the number of peripheral pixels (in this embodiment, two). The division unit 2703 outputs, for each of the limited pixels, a division result for the limited pixel as pixel values after correction of peripheral pixels of the limited pixel.

When there is fluctuation in pixel values of the peripheral pixels, if the pixel values of the peripheral pixels are adjusted by the same adjustment amount, a pixel value of a part of the peripheral pixels is a value outside the predetermined range. As a result, a change in brightness of the limited pixel sometimes cannot be sufficiently compensated. According to this embodiment, corrected image data in which pixel values of pixels around a limited pixel are adjusted by an adjustment amount for equalizing pixel values of the pixels around the limited pixel one another. Consequently, to prevent a pixel value of a part of the peripheral pixels from becoming a value outside the predetermined range, it is possible to increase an adjustment for pixel values of the other peripheral pixels. It is possible to compensate a change in brightness of the limited pixel more accurately than in the sixth embodiment.

A calculation method for pixel values after correction of peripheral pixels is not limited to the method explained above. For example, a correction value for the peripheral pixels may be adjusted according to input pixel values of the peripheral pixels. Specifically, the correction value for the peripheral pixels may be adjusted by weight corresponding to a ratio of the input pixel values among the peripheral pixels.

In the sixth to eighth embodiments, the processing for calculating pixel values after correction of pixels may be performed in parallel or may not be performed in parallel. For example, the pixels may be selected in order from upper left to lower right of the screen to calculate a pixel value for correction for each of pixels. Specifically, the pixels may be selected in order from the left to right for each of lines to calculate a pixel value after correction for each of the pixels. Then, in some case, a pixel to be processed was selected as a peripheral pixel in the past and a pixel value of the pixel is adjusted. In that case, correction data and a saturation amount may be calculated using a pixel value after adjustment or an input pixel value may be stored to calculate correction data and a saturation amount using the input pixel value.

The configurations and the technical ideas in the first to eighth embodiments explained above can be combined as much as possible. For example, the configuration in the sixth embodiment may be changed on the basis of the technical idea in the second embodiment. Specifically, in the sixth embodiment, a correction value for pixels around a limited pixel, which is not an isolated limited pixel, does not have to be adjusted to compensate a change in brightness due to limitation of a pixel value of the limited pixel. The configuration in the sixth embodiment may be changed on the basis of the technical idea in the first embodiment. Specifically, in the sixth embodiment, a pixel value of a limited pixel may be limited such that a hue represented by a pixel value before limitation is kept. An adjustment amount for adjusting a correction value for pixels around one limited pixel in order to compensate a change in the brightness of the limited pixel may be determined such that a hue represented by the adjustment amount coincides with a hue represented by a pixel value before limitation of the limited pixel.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2012-219476, filed on Oct. 1, 2012, Japanese Patent Application No. 2013-112644, filed on May 29, 2013, and Japanese Patent Application No. 2013-182851, filed on Sep. 4, 2013, which are hereby incorporated by reference herein in their entirety.

What is claimed is:

1. A display apparatus comprising:
a display unit configured to display an image based on image data; and
an output unit configured to generate image data in which, among pixel values of image data generated by applying predetermined image processing to input image data, a pixel value outside a predetermined range is limited to a value within the predetermined range and a pixel value of a pixel around the pixel, the pixel value of which is limited, is adjusted such that a change in brightness due to the limitation of the pixel value outside the predetermined range is suppressed, and configured to output the image data to the display unit.

2. The display apparatus according to claim 1, wherein the output unit includes:
an image processing unit configured to generate processed image data by applying the predetermined image processing to the input image data;
a limiting unit configured to generate limited image data by limiting a pixel value outside the predetermined range, among pixel values of the processed image data, to a value within the predetermined range; and
a suppressing unit configured to generate suppressed image data from the limited image data by adjusting a pixel value of a pixel around a limited pixel, which is a pixel the pixel value of which is limited by the limiting unit, such that a change in brightness of the limited pixel due to the limitation of the pixel value by the limiting unit is suppressed, and configured to output the suppressed image data to the display unit.

3. The display apparatus according to claim 2, wherein
the limiting unit limits a pixel value such that a hue represented by the pixel value before the limitation is kept, and
the suppressing unit determines an adjustment amount such that a hue, which is represented by an amount of adjusting a pixel value given to a pixel around one limited pixel in order to suppress a change in brightness of the one limited pixel, coincides with a hue represented by a pixel value before limitation of the limited pixel.

4. The display apparatus according to claim 2, wherein the suppressing unit determines, in a case of causing a plurality of pixels to suppress a change in brightness of one limited pixel, amounts of adjusting pixel values of the plurality of pixels such that the amounts of adjusting pixel values are equal to one another among the plurality of pixels.

5. The display apparatus according to claim 2, wherein, when a pixel, the pixel value after adjustment of which is a value outside the predetermined range, is present, the suppressing unit limits a total amount of adjusting a pixel value of the pixel such that the pixel value after the adjustment of the pixel is a value within the predetermined range.

6. The display apparatus according to claim 5, wherein the suppressing unit limits the total adjustment amount such that a hue represented by the total adjustment amount after the adjustment coincides with a hue represented by the total adjustment amount before the adjustment.

7. The display apparatus according to claim 5, further comprising:
a light emitting unit configured to emit light; and
a control unit configured to cause the light emitting unit to emit light, wherein
the display unit displays an image by transmitting, at transmittance based on image data, the light emitted from the light emitting unit, and
the control unit controls light emission brightness of the light emitting unit such that a change in brightness due to the limitation of the total adjustment amount is suppressed.

8. The display apparatus according to claim 5, wherein the suppressing unit adjusts a pixel value of a pixel around a total adjustment amount limited pixel, which is a pixel the total adjustment amount of which is limited, such that a change in brightness due to the limitation of the total adjustment amount limited pixel is suppressed.

9. The display apparatus according to claim 1, wherein
the output unit includes:
a correction data generating unit configured to generate, on the basis of the input image data and the predetermined image processing, correction data representing a correction value for each pixel for correcting a pixel value of the input image data to a pixel value applied with the predetermined image processing;
a detecting unit configured to detect, on the basis of the input image data and the correction data, a pixel, the a pixel value of which is set to a value outside the predetermined range by applying the predetermined image processing to the input image data, as a limited pixel; and
an image generating unit configured to generate, on the basis of the input image data, the correction data, and a detection result of the detecting unit, corrected image data in which, among the pixel values of the image data generated by applying the predetermined image processing to the input image data, the pixel value outside the predetermined range is limited to the value within the predetermined range and in which the pixel value of the pixel around the pixel, the pixel value of which is limited, is adjusted such that the change in brightness due to the limitation of the pixel value outside the predetermined range is suppressed.

10. The display apparatus according to claim 9, wherein the image generating unit includes:
an adjusting unit configured to generate adjustment and correction data by adjusting a correction value for the limited pixel such that a pixel value after the predetermined image processing of the limited pixel is limited to a value within the predetermined range and adjusting a correction value for a pixel around the limited pixel such that a change in brightness due to the limitation of the pixel value of the limited pixel is suppressed; and
a first correcting unit configured to generate the corrected image data by correcting pixel values of the input image data by using the adjustment and correction data.

11. The display apparatus according to claim 9, wherein the image generating unit generates corrected image data in which pixel values of pixels around the limited pixel are adjusted by a same adjustment amount.

12. The display apparatus according to claim 9, wherein the image generating unit generates corrected image data in which pixel values of pixels around the limited pixel are adjusted by an adjustment amount at which the pixel values of these pixels are equalized.

13. The display apparatus according to claim 9, wherein the output unit further includes a second correcting unit configured to correct, when a change in brightness due to the limitation of the pixel value of the limited pixel cannot be sufficiently suppressed by a pixel around the limited pixel, a pixel value of a pixel on an outer side of the pixel around the limited pixel among pixel values of the corrected image data such that the change in brightness that cannot be sufficiently suppressed by the pixel around the limited pixel is suppressed.

14. The display apparatus according to claim 1, wherein the output unit determines whether the limited pixel is a locally present isolated limited pixel, generates image data in which, among the pixel values of the image data generated by applying the predetermined image processing to the input image data, a pixel value of the limited pixel is limited to the value within the predetermined range and in which a pixel value of a pixel around the isolated limited pixel is adjusted such that a change in brightness due to limitation of a pixel value of the isolated limited pixel is suppressed, and outputs the image data to the display unit.

15. The display apparatus according to claim 14, wherein the output unit determines that the limited pixel is the isolated limited pixel when the number of limited pixels present around one pixel is equal to or smaller than a predetermined number.

16. The display apparatus according to claim 1, further comprising:
a light emitting unit configured to emit light;
an acquiring unit configured to acquire a characteristic value of the input image data; and
a control unit configured to cause the light emitting unit to emit light at light emission brightness based on the characteristic value acquired by the acquiring unit, wherein
the display unit displays an image by transmitting, at transmittance based on image data, the light emitted from the light emitting unit, and
the predetermined image processing is processing for correcting the input image data in accordance with light emission brightness of the light emitting unit such that brightness of an image displayed on a screen is equal both when the light emitting unit is caused to emit light at predetermined light emission brightness and when the light emitting unit is caused to emit light at light emission brightness based on the characteristic value.

17. A control method for a display apparatus including a display unit configured to display an image based on image data, the control method comprising:
generating image data in which, among pixel values of image data generated by applying predetermined image processing to input image data, a pixel value outside a predetermined range is limited to a value within the predetermined range and in which a pixel value of a pixel around a pixel, the pixel value of which is limited, is adjusted such that a change in brightness due to the limitation of the pixel value outside the predetermined range is suppressed; and
outputting the image data thus generated to the display unit.
